(19) United States
(12) Patent Application Publication
(10) Pub. No.: US 2002/0133441 A1
(43) Pub. Date: Sep. 19, 2002

(54) Methods and systems for identifying attributable errors in financial processes

(76) Inventor: David T. Tanaka, Durham, NC (US)

Correspondence Address: JENKINS & WILSON, PA, 3100 TOWER BLVD, SUITE 1400, DURHAM, NC, 27707, US

(21) Appl. No.: 10/098,022

(22) Filed: Mar. 13, 2002

Related U.S. Application Data
(60) Provisional application No. 60/275,875, filed on Mar. 14, 2001.

(51) Int. Cl. G06F 17/60

(52) U.S. Cl. 705/35

(57) ABSTRACT

A method and system for statistically analyzing financial databases to identify special causes responsible for systematic variances is disclosed. Financial data are obtained from any compiled source and compared against either other members of the data set or to externally provided financial controls. Computed data means and variances are used to characterize the behavior of individual data sets with respect to expected means. Statistically significant variances from the anticipated behavior of the data set form the basis for follow-up multivariate and survival analysis of the data to identify statistically significant financial factors (special causes) contributing to the variances. Identification of the financial factors responsible for the variances in the data provide the means by which process changes are designed, implemented and monitored over time to minimize subsequent variances in the compiled data set.

### RELATED APPLICATIONS

This application claims the benefit of U.S. Provisional Patent Application No. 60/275,875 filed Mar. 14, 2001, the disclosure of which is incorporated herein by reference in its entirety.

### TECHNICAL FIELD

The present invention relates generally to statistical analyses of financial information relayed over computer networks or found resident within financial databases. More particularly, the present invention relates to methods and systems for examining data elements within a financial data set to identify causes responsible for data variance and for correcting financial processes based on identification of the causes for the data variance.

### BACKGROUND ART

The nearly exponential growth of financial information resident within computer databases, coupled with the need to rapidly and accurately identify systematic processing errors, requires new analytical approaches. For example, one financial problem that needs to be solved is minimizing the difference between actual and expected payment on a large number of accounts. Traditional approaches to detecting and correcting large variances from expected payments usually employ a variety of methods to sort the data set with the magnitude of the variance as the filter for the sort. Resources are then directed to correcting individual accounts in a hierarchical manner based on the magnitude of the variance from expected payment. In order to maximize the cost—benefit of this latter process, some arbitrary rule is often applied to identify a lower limit of variance that will be tolerated with the process below which no additional resources would be expended to correct the residual error. For example, all accounts for which actual and expected payment differ by less than 10% may be ignored. Although shortterm gains can be maximized with this approach, systematic causes for the variance in financial performance are neither detected nor corrected. Moreover, the total losses attributable to the systematic error within the system that exist below the arbitrarily defined lower limit of variance may far exceed the expected recovery of those accounts for which variance exceeds the limit.

There have been previous attempts to statistically analyze financial data sets with the specific aim to characterize the performance of the financial process. In this connection, summarized data are often expressed as ‘means’ (i.e., average) or ‘medians’ (most common), and these values are used to form subsequent statistical comparisons of the data. Despite this widespread practice, this approach yields meaningful results only if the data are distributed in a normal or Gaussian manner. In fact, as a general rule financial data are not normally distributed and consistently deviate from this behavior. Thus, conventional statistical measures, such as means and medians, are often unsuitable for comparing financial data.

Another limitation of existing methods for analyzing financial performances is the inability to accurately identify either individual factors (special causes) or their interactions which may contribute to the variance. This limitation often requires financial planners to make their ‘best guess’ as to the causative elements within the financial process responsible for the error. As used herein, the term ‘financial process’ refers to any process for which performance is measured based on money. Attempts to create process change using ‘best guess’ approaches are simplistic at best and dangerous at worst. Indeed, truly random variability of the financial processes may be mistaken for having a causal basis with subsequent unnecessary corrective actions undertaken to ‘fix’ the problems. Such unwarranted tinkering with the process may actually result in even greater process variance and costs (see Deming, The New Economics; and Latzko and Saunders, Four Days with Dr. Deming).

A further disadvantage to commonly used methods to analyze financial performance results from the sheer magnitude of the data. Even modest databases can contain thousands of rows of data, and databases with hundreds of thousands or even millions of rows are common. Faced with this ‘sea’ of data, financial officers are forced to rely more and more heavily on ‘derivative’ or summarized data in order to gain insight into the data. Such reductionary approaches often smooth out subtle patterns within the data set and can hide costly process errors.

From the foregoing, it is seen that a need exists for improved methods and systems by which financial planners may efficiently examine an entire financial data set for contributory factors responsible for residual errors. In particular, a need exists for methods and systems that can further identify potential interactions with each special cause and that can assess the impact of any subsequent change in process. It is further desirable that the results of financial analysis be displayed graphically to facilitate the understanding of the impact of special causes as well as to effectively communicate relationships between factors comprised of thousands of individual data elements.

The need for improved financial analysis methods and systems is particularly acute in the healthcare industry. Healthcare provider organizations, such as hospitals, spend millions of dollars each year in collecting payment for insurance claims. The conventional statistical analysis techniques described above are unsuitable for analyzing claims-related data because such data may not be normally distributed. Accordingly, causes for revenue shortfalls in the healthcare-related financial area cannot be determined with certainty using conventional statistical analysis techniques. Thus, there exists a need for improved methods and systems for analyzing healthcare-related financial data.

### DISCLOSURE OF THE INVENTION

In accordance with these needs and limitations of current methodologies, the present invention includes methods and systems for statistically analyzing financial data in organized databases or data sets. The data may be examined in their entirety or by being further subdivided according to the needs of the user. In addition to supporting standard financial reporting practices, the statistical analysis methods and systems described herein examine each data element's contribution to both the variance as well as mean. Subsequent follow-up multivariate, regression, control charts (Shewhart) and survival statistical analyses are systematically applied to further identify, quantify, and rank the data element's contribution with respect to the outcome of the process goals. Relationships of data elements to each other are graphically depicted to provide the user with additional means of rapid identification and isolation of potential special causes and provides the means through which all data elements and their relationship/contribution to the process goals can be rapidly assessed.

In the described invention, financial data being analyzed are obtained from either databases resident on a computer or after retrieval in electronic form. The submission of the data can be through local area networks (LANs), over e-mail, over infrared transmission, on transportable media (e.g., floppy disks, optical disks, high-density disks), over the Internet, or through high-speed data transmission lines (e.g., ISDN, DSL, cable). The initial structure of the retrieved financial data can be a general spreadsheet format (e.g., EXCEL™), text format, database format (e.g., ACCESS™ or other open database connectivity (ODBC)-compliant form), orASCII.

Once the data are resident within a computer, the data are sorted according to predetermined criteria. For example, accounts payable for healthcare services provided to insured patients may be sorted with respect to accounts, service dates, and insurance claims activity. Additional computational elements are added to the data sets to facilitate subsequent statistical analyses. The data elements can be of a general nature but must include certain characteristics as will be described in more detail below.

Once the data set has been prepared in this manner, the data are summarized with respect to time. This time-based examination of the data includes, but is not limited to time to invoice creation, time to first payment or denial, time from service to final payment or denial. The data are plotted using histograms to depict the relative frequency and/or probability of each time element. In addition, each data element is plotted as a continuous variable with respect to time. These time-based analyses form the basis for standard financial reporting with respect to time (e.g., days receivables outstanding (DRO), aging of accounts, mean and median time of accounts receivables, etc.).

An important aspect of time-based analyses includes the ability to assess the relative contribution or characteristic of different data elements on the time-based process. Current methodology typically compares timeliness of payment or claims processing by individual payors by examining measures of their means or median times to payment/claims denial. For example, in the healthcare industry, current methodology compares timeliness of payment or claims processing by insurance companies for healthcare services rendered to insured patients. Such comparison conventionally includes comparing mean or median payment times among insurers. This standard approach is limited by the general characteristic of all such data as non-parametric (i.e., not normally distributed), which in turn renders meaningful comparisons between data sets moot. For example, for a given insurer, most payments may occur within a predetermined time period, such as 60 days. However, some claims may not be paid or processed for a number of months. Such statistical outliers make the distribution of time-related payment data non-normal or non-Gaussian and therefore unsuitable for comparison using conventional statistical techniques.

According to one aspect of the present invention, this limitation is eliminated through the novel application of the Kaplan-Meier statistic. The Kaplan-Meier statistic is conventionally used in survival studies to compare the survival time of a group of patients treated with a certain drug versus patients that were not treated with the drug. In contrast to its use as a survival statistic, in the present invention, Kaplan-Meier statistics are applied to time-based financial and process data. For example, in the healthcare industry, Kaplan-Meier survival curves may be generated to compare the time of payment of insurance claims by various insurance companies. Alternatively, a more general application of this statistic would be to compare other time-based financial processes, e.g. time from date of service to invoice generation. The application of the Kaplan-Meier statistic according to the invention is based on its suitability to handle non-parametric, time-based data with a clearly defined start and end. These characteristics, coupled with the Kaplan-Meier capability to compare any number of different categorical or nominal data elements together with software-specific capabilities to eliminate competing causes (see below) permit rapid, statistically rigorous comparisons of timeliness of payment or process.

Another aspect of the invention includes a method for comparing the actual outcomes of the financial process (e.g., charges submitted, payments received) with modeled outcomes. Creation of the models can be performed either by the user or through the applied use of any suitable third party software designed for such use (e.g., CHARGEMASTER®). All relevant data elements are plotted on a X-Y coordinate graph with the modeled data arranged along the X-axis and the actual responses arrayed along the Y-axis. It is to be appreciated by even casual users that a model which accurately predicts the outcome will be characterized by a diagonal line characterized by a slope of 1 and a regression (r, a measure of variance) of 1.0. Statistically significant departure from the model indicates a need to perform follow-up statistical analyses to identify the most likely source(s) of the error. In this connection, it should be noted that significant deviations in slope often indicate single process errors while large variances about the common slope indicate the present of multiple error factors.

Assessing the relative contribution of each factor in the model together with the separate influence or impact of process errors (e.g., site of service) is achieved through the separate application of multivariate analysis. For example, in the healthcare industry, it may be desirable to determine why one site of service, such as a clinic, receives payment on insurance claims faster than another site of service. Conventional single-variable statistical analysis may be unsuitable for making this determination. However, multivariate analysis allows the user to assess the statistical likelihood that a factor or combination of factors contributes to the model's outcome or reduces model error. Once the statistically relevant factors are identified, each factor (or combination thereof) in the model is perturbed (adjusted by an arbitrary amount, typically by 10% of its nominal value) and the new model compared to the actual outcomes. This reiterative process is continued until the factor(s) most responsible for the residual error are identified. For example, in the clinic site time of payment scenario discussed above, multivariate analysis may indicate that clinic A receives payment on claims before clinic B because clinic A meets on Mondays and clinic B meets on Fridays.

Once suitable candidates for process errors are identified, the entire process is continuously monitored for statistical control through the use of Shewhart charting. This tool developed for manufacturing processes is applied in this invention to assist with the maintenance and monitoring functions inherent in any practical invention pertaining to process control.

From this description, it can be appreciated that the invention overcomes the limitations in the prior art. To wit, the present invention addresses these limitations by: 1) examining the data set in its entirety rather than by sampling of the data; 2) incorporating graphical analyses together with numerical assessments to characterize the integrity (i.e., accuracy and efficiency) of the process; 3) identifying contributory factors or combinations of factors responsible for residual error; 4) avoiding analysis errors associated with assuming normally distributed data; and 5) providing the means by which any modifications of the financial process can be monitored and rigorously compared to expected outcomes.

A more complete understanding of the nature and scope of this invention is available from the following detailed description and accompanying drawings which depict the general flow as well as specific steps in which this invention may be deployed.

Accordingly, it is an object of the invention to provide improved methods and systems for identifying attributable errors in financial processes.

Some of the objects of the invention having been stated hereinabove, other objects will become evident as the description proceeds when taken in connection with the accompanying drawings as best described hereinbelow.

### BRIEF DESCRIPTION OF DRAWINGS

Preferred embodiments of the present invention will now be explained with reference to the accompanying drawings, of which:

FIG. 1 is a block diagram illustrating a computer including statistical analysis software usable in the methods and systems for identifying attributable errors in financial processes according to embodiments of the present invention;

FIG. 2 is a flow diagram illustrating the general steps taken to acquire financial data, process the data, analyze the data, and generate reports according to an embodiment of the present invention;

FIGS. 3A and 3B are tables illustrating exemplary categories for organizing financial data according to an embodiment of the present invention;

FIGS. 4A and 4B are tables respectively illustrating unsorted and sorted financial data according to an embodiment of the present invention;

FIG. 4C is a computer monitor screen shot illustrating an interface for sorting financial data according to an embodiment of the present invention;

FIG. 5A is a table illustrating exemplary calculation fields added to financial data prior to analysis according to an embodiment of the present invention;

FIG. 5B is a computer monitor screen shot illustrating an exemplary algorithm for producing the account activity identifiers illustrated in FIG. 5A;

FIGS. 6A-6E are tables illustrating conventional statistical measures applied to financial data;

FIG. 7A is a histogram and FIGS. 7B and 7C are tables illustrating a representative analysis of data variance by category according to an embodiment of the present invention;

FIG. 7D is a least squares means table and FIG. 7E is a least squares means graph illustrating analysis of variance among data categories according to an embodiment of the present invention;

FIG. 7F is a least squares means graph illustrating nested analysis of variance by category according to an embodiment of the present invention;

FIGS. 8A and 8C are graphs and FIGS. 8B and 8D are tables illustrating a comparison between actual and modeled revenue payments according to an embodiment of the present invention;

FIG. 9 is a graph and a table illustrating a bivariate fit of account payments to modeled revenues according to an embodiment of the present invention;

FIG. 10 is an enlargement of an area of the graph of FIG. 9 illustrating a bivariate fit of account payments to modeled revenues according to an embodiment of the present invention;

FIG. 11 is a graph of the difference between account payments and modeled revenues for one of the vertical data structures identified in FIG. 10 grouped according to diagnostic related groups (DRGs) according to an embodiment of the present invention;

FIGS. 12A-12C are graphs of account payments versus modeled revenues and length of stay for different DRGs according to an embodiment of the present invention;

FIGS. 13A and 13B are graphs illustrating isolation of two payment groups according to an embodiment of the present invention;

FIG. 14 is a graph illustrating isolation of under-performing accounts using a control charting technique according to an embodiment of the present invention;

FIG. 15 is a graph illustrating identification and elimination of DRGs with the largest negative mean variance according to an embodiment of the present invention;

FIGS. 16A and 16B are tables and FIGS. 16C-16E are graphs illustrating factorial analysis of DRGs with large negative means variance according to an embodiment of the present invention; and

FIG. 17A is a graph and FIG. 17B is a table illustrating the use of survival plotting to characterize and compare independent time-based processes.

### DETAILED DESCRIPTION OF THE INVENTION COMPUTER-RELATED METHOD STEPS

The present invention includes methods and systems for analyzing financial data to identify attributable errors in financial processes. These methods and systems include the application of both conventional and non-conventional statistical analysis techniques to identify these errors. Applying such statistical analysis techniques involves complex computations on large data sets. Therefore, such analysis is most easily performed using statistical analysis software executing on a computer, such as a personal computer.

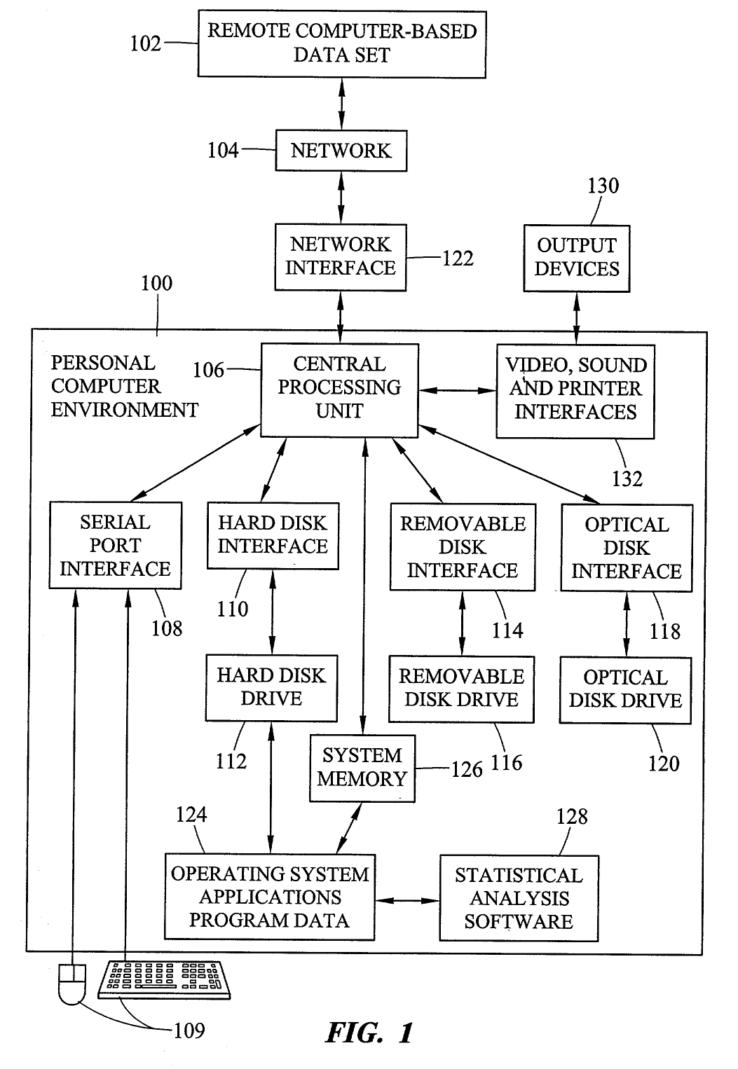

FIG. 1 illustrates a personal computer 100, its associated subsystems, and a remote-computer-based dataset 102 to which the methods and systems for identifying attributable errors in financial processes are applied. Those skilled in the art will appreciate that the methods and systems for identifying attributable errors in financial processes according to embodiments of the present invention are not limited to using a personal computer. Other computational platforms, including hand-held devices, mini-computers, mainframe computers, or any other platform capable of performing statistical calculations are intended to be within the scope of the invention. Moreover, the steps for implementing the methods and systems for identifying attributable errors in financial processes can be implemented in a multi-user or distributed environment wherein the financial data being analyzed are resident on different computers connected through wireline or wireless communication links. In addition, program modules used to statistically analyze financial data may be located in both local, i.e., on the same machine as the data being analyzed, as well as remote devices.

In FIG. 1, remote financial data set 102 may initially be resident on a computer connected to personal computer 100 via a network 104. Network 104 may be any type of wireless or wireline network over which information can be exchanged. In one example, network 104 may be the local area network interconnecting computers containing patient financial data at a hospital.

Personal computer 100 includes various hardware and software elements that facilitate the collection and analysis of financial data set 102. For example, in the illustrated embodiment, personal computer 100 includes a central processing unit 106 for executing programs for analyzing data set 102 and for controlling the overall operations of personal computer 100. Central processing unit 106 may communicate with various input/output devices to acquire financial data set 102. For example, central processing unit 106 may communicate with a serial port interface 108 to receive financial data set 102 from one or more serial input devices 109, a hard disk interface 110 to retrieve financial data stored on a magnetic disk accessible by hard disk drive 112, a removable disk interface 114 to retrieve financial data from a removable disk accessible by removable disk drive 116, an optical disk interface 118 to retrieve financial data stored on an optical disk readable by optical disk drive 120 or a network interface 122 to retrieve financial data via network 104. Any method for collecting financial data is intended to be within the scope of the invention.

In order to facilitate analysis of financial data, personal computer 100 may include software 124, such as an operating system and one or more application programs resident on a fixed magnetic disk, i.e., the hard disk, or in system memory 126. Of particular importance to the methods and systems for identifying attributable errors in financial processes according to embodiments of the present invention is statistical analysis software 128. Statistical analysis software 128 may be any software capable of receiving financial data from a database, sorting the data, performing statistical calculations on the data, and visually displaying output to an end user. Exemplary commercially available statistical analysis software suitable for use with embodiments of the present invention is the JMP® software available from SAS Institute of Cary, N.C. The JMP® program provides a variety of tools that allow financial data to be analyzed, subsetted, and re-analyzed. However, the present invention is not limited to using the JMP® program. Any statistical analysis software capable of performing the operations described herein is intended to be within the scope of the invention.

Another important aspect of the methods and systems for identifying attributable errors in financial processes is the application of visual statistics to financial data. Financial data has conventionally been stored in spreadsheet or database format. Because such financial spreadsheets or databases typically include thousands of entries, identifying systematic errors in a financial process can be difficult, if not impossible. According to embodiments of the present invention, financial data is sorted and displayed to the user in graphical format to allow the user to analyze variance in the entire dataset and in subsets of the entire dataset. Statistical analysis software 128 allows financial data to be displayed to the user in graphical format via one or more output devices 130, such as a video display device, via output device interface 132. Exemplary output formats suitable for the application of visual statistics to financial data will be discussed in more detail below.

Process Flow for Identifying Attributable Errors in Financial Processes

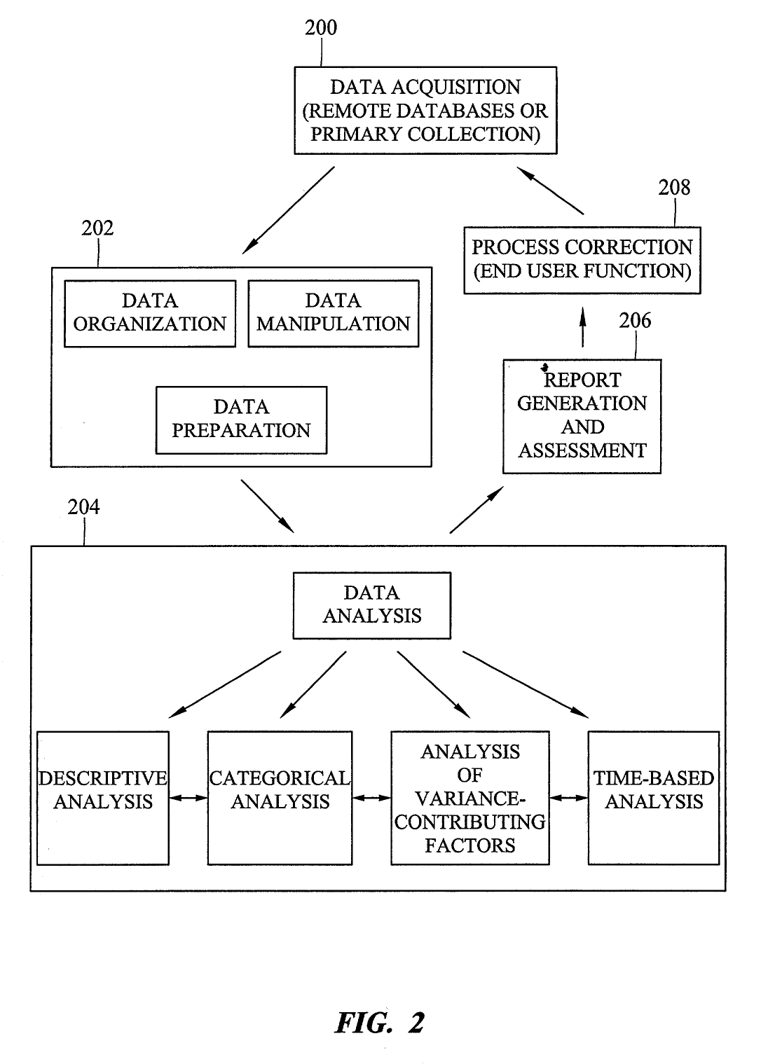

FIG. 2 is a flow diagram illustrating steps for identifying attributable errors in financial processes according to embodiments of the present invention. In FIG. 2, the process begins with data acquisition 200, which includes collecting financial data from a database or other source. The next step 202 is data organization, preparation, and manipulation, which includes organizing data into predetermined data sets, sorting data within the data sets, etc. The next step is data analysis 204, which includes descriptive analysis, categorical analysis, analysis of variance, and time-based analysis. The next step 206 is report generation and assessment, which includes outputting data in tangible format so that it can be analyzed for model correction or process improvement purposes. Finally, the last step 208 is process correction, which includes applying the results of data analysis 204 to improve a financial process. It is understood that the steps illustrated in FIG. 2 may be performed iteratively to continuously improve a financial process. It is also understood that the steps illustrated in FIG. 2 may be automated, e.g., by computer software specifically designed for identifying attributable errors in financial processes. Each of the steps in FIG. 2 will now be discussed in further detail.

### Data Organization

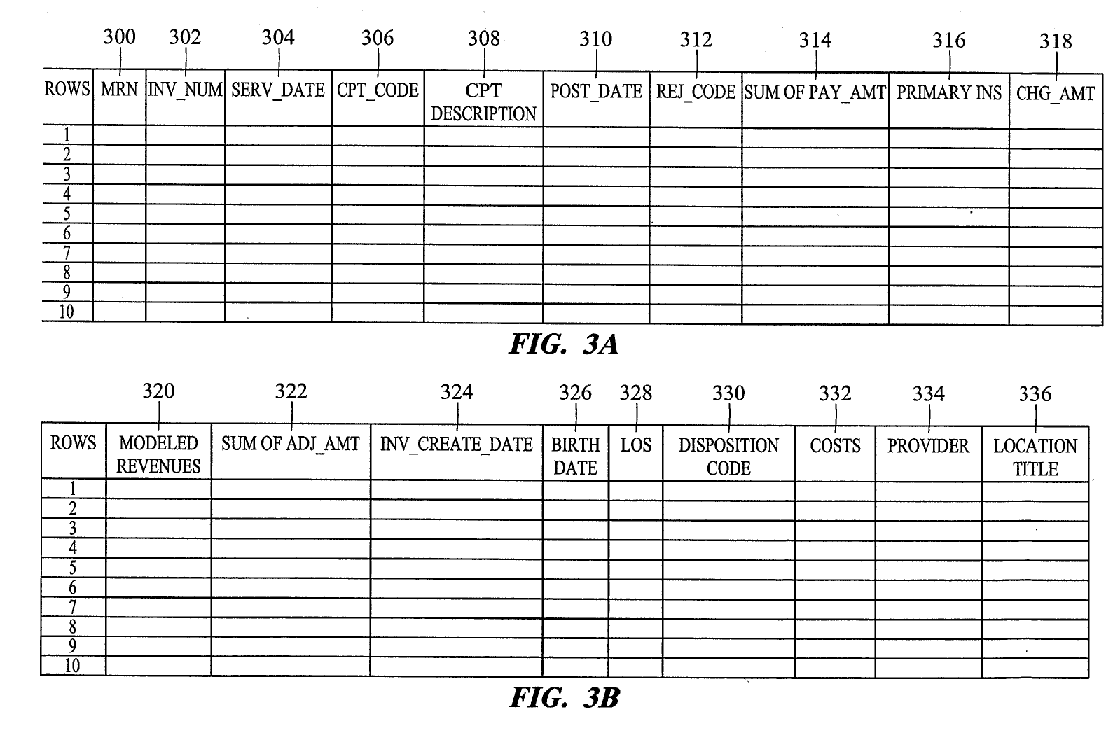

The steps for data organization illustrated in FIG. 2 will be described in detail with regard to FIGS. 3A and 3B. FIGS. 3A and 3B are templates created using the JMP® program for organizing data relating to the provision of medical services. The JMP® program presents the user with a standard table-like interface and allows the user to import data to be analyzed into the table-like interface. In the examples illustrated in FIG. 3A and 3B, the tables contain column headers for columns in the table that store healthcare-related financial data. The cells in the tables store actual data being analyzed, which has been omitted in FIGS. 3A and 3B. Each of the data fields used for organizing healthcare-related financial data will now be discussed in more detail.

Referring to FIG. 3A, column 300 stores the medical record number (MRN) for a patient. Column 302 stores the invoice number associated with a given service provided to the patient. Column 304 stores the service date on which the service was provided. Column 306 stores the clinical processing terminology (CPT) code associated with the service. Column 308 stores the CPT description for the service. Column 310 stores the date on which an invoice was posted to an account. Column 312 stores a rejection code if an invoice has been rejected by a payor. Column 314 stores the amount paid on an account. Column 316 stores an identifier for the primary insurance carrier associated with the account. Column 318 stores the amount charged on the account.

Referring to the template in FIG. 3B, column 320 stores modeled revenues for the account. Column 322 stores a summary of adjustments made to the account. Column 324 stores the invoice creation date. Column 326 stores the birthdate of the patient. Column 328 stores the length of the stay for the service being provided. Column 330 stores the disposition code of the matter, e.g., whether the patient was discharged to his or her home, transferred to another facility, or died. Column 332 stores the costs associated with the service. Values stored in this field are used to determine whether the services are profitable. Column 334 stores the service provider, i.e., the physician that performed the service. Column 336 stores the location associated with the service, such as a hospital or clinic location.

It is understood that the fields illustrated in FIGS. 3A and 3B are merely examples of fields useful for analyzing healthcare-related financial data. Additional or substitute fields may be included without departing from the scope of the invention.

### Data Manipulation

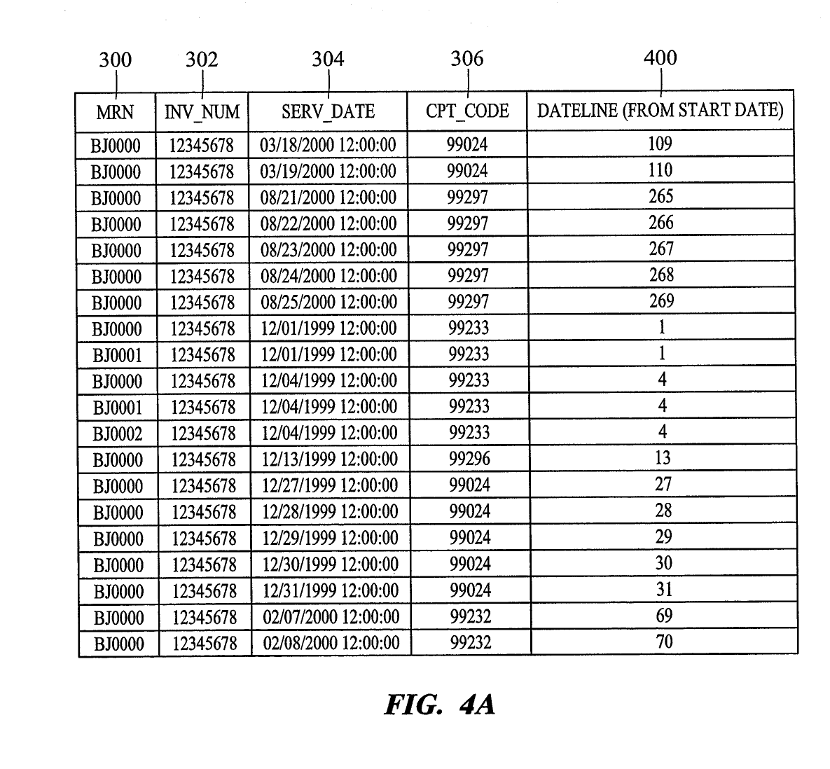

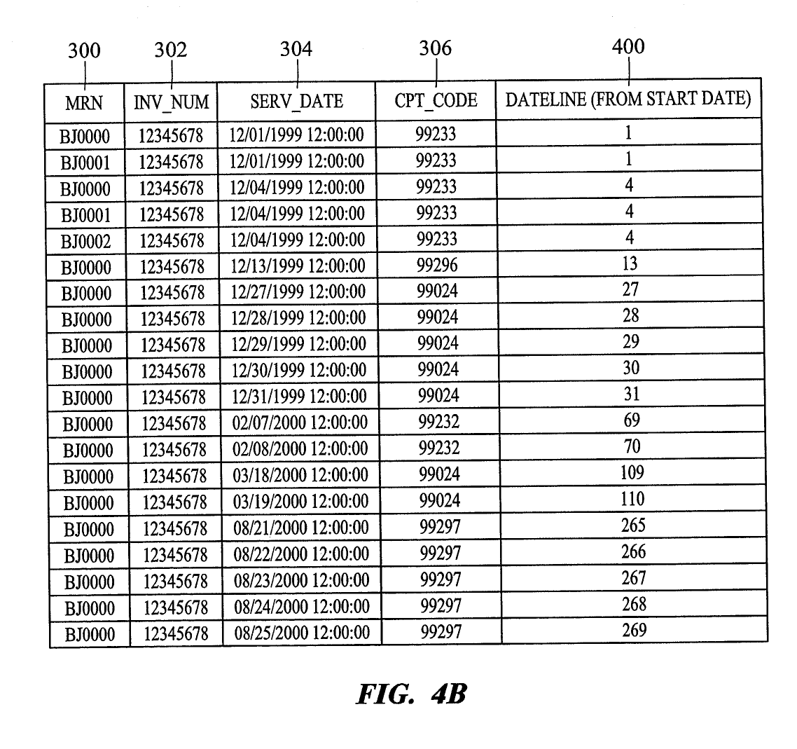

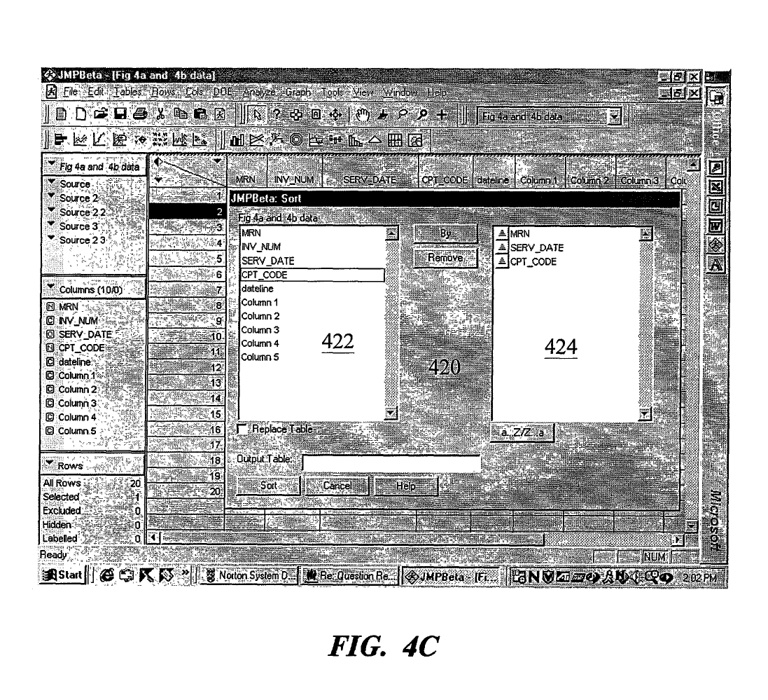

Once data is acquired and organized into a format similar to that illustrated in FIGS. 3A and 3B, the data is manipulated by performing preliminary calculations on the data and by sorting the data. FIGS. 4A and 4B respectively illustrate examples of sorted and unsorted data. In FIG. 4A, columns 300, 302, 304, and 306 contain data extracted directly from the correspondingly-numbered fields in FIG. 3A. A new data column 400 contains dateline information indicating the day since a predetermined start date. The values in column 400 are calculated based on the post date values in column 310 illustrated in FIG. 3A and the current date. For example, if an invoice was posted on the start date, a value of ‘1’ would be entered in column 400.

FIG. 4B illustrates sorted data corresponding to the unsorted data in FIG. 4A. In FIG. 4B, the data has been sorted first by invoice number, as illustrated in column 302, then by service date, as illustrated in column 304, then by CPT code, as illustrated in column 306, then by dateline (column 400) finally by payment field (not shown). This nested sorting can be formed by using commercially available statistical analysis software, such as the JMP® program or using a commercially available spreadsheet, such as the EXCEL™ spreadsheet.

FIG. 4C is a screen shot of an interface for sorting financial data using the JMP® program. In FIG. 4C, the JMP® program presents the user with a dialog box 420. The dialog box 420 includes a first portion 422 that includes candidate fields for performing a sort. The candidate fields correspond to the fields in the tables illustrated in FIG. 4A and 4B. The dialog box 420 includes a second portion 424 that stores fields selected by the user for a sort. In the illustrated example, the user has selected medical record number, service date, and CPT code as the exemplary fields for sorting the data.

### Data Preparation

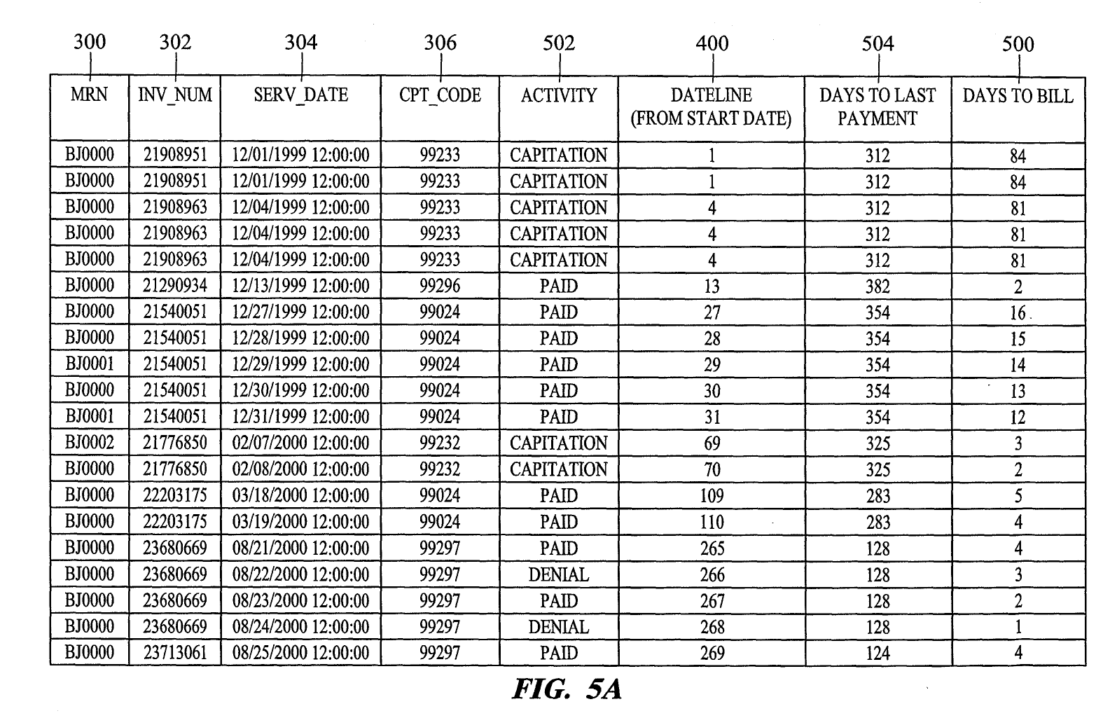

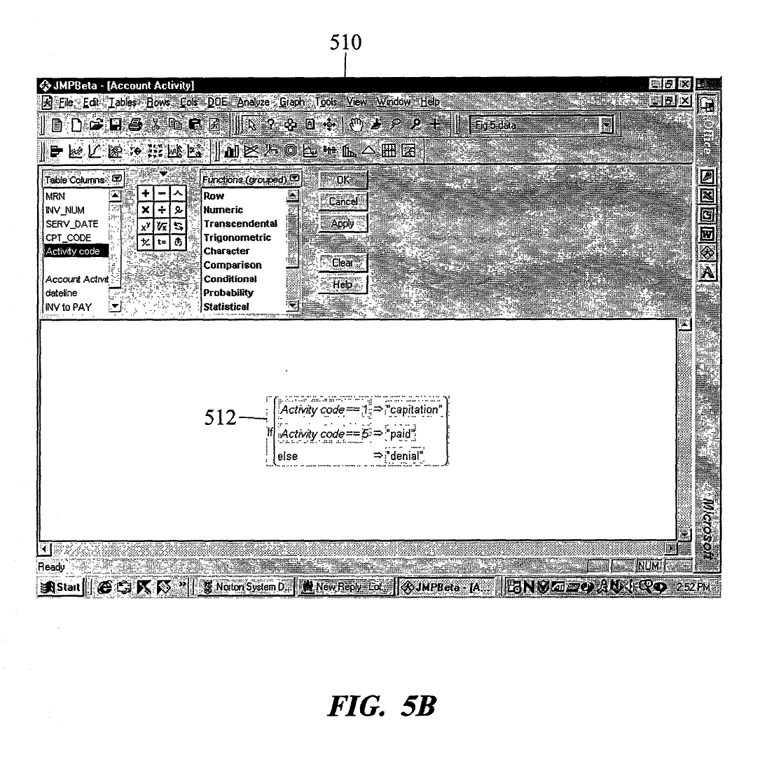

Using the sorted data set described above with respect to FIG. 4B, additional calculated data fields are created to further characterize the data. FIG. 5A illustrates exemplary data fields that may be added to the sorted data. These fields include days from service date to charge processing date(s) (column 500), days from service date to payment date(s) (column 400), the presence of duplicate filings, the presence of partial, capitated, and denied payments (column 502). A capitated payment is a payment that the payor indicates is final and is less than the entire amount. A partial payment is a payment that may be supplemented later by the payor. The days from service to charge processing dates stored in column 500 indicate that amount time after a service was provided before the bill was mailed. Days to last payment column 504 represents the elapsed time since a payment, denial, partial payment, or capitated payment was received. Creation of the calculated fields are approached in the following general manner: 1) identify the field of interest (e.g., payments); 2) identify the data element or data characteristic of interest (e.g., zero payments in the payment field); 3) create a macro program or other suitable search algorithm to isolate the characteristic of interest (for a representative example); and 4) display search results.

Commercially available software packages, such as the above-referenced JMP®, EXCELS™, or ACCESS™ programs either include or allow the user to create a search macro. Hence, a detailed description of the operation of the search macro is not included herein.

FIG. 5B is a screen shot illustrating an exemplary algorithm for producing the account activity identifiers illustrated in column 502 of FIG. 5A. In FIG. 5B, screen shot 510 includes algorithm block 512 that includes a user-defined algorithm for converting and activity code in a financial dataset into a plain language identifier corresponding to the activity code. In the illustrated example, algorithm block 512 is an if-else loop. In the if-else loop, if the activity code is equal to 1, then the identifier stored in column 502 in FIG. 5A is “capitation.” If the activity code is 5, then the activity stored in column 502 in FIG. 5A is “paid.” If the activity code is neither 1 nor 5, then the identifier stored in column 502 in FIG. 5A is “paid.” Using algorithm blocks, such as algorithm block 512 illustrated in FIG. 5B, the user can convert data in a dataset from unrecognizable to recognizable format.

### Data Analyses

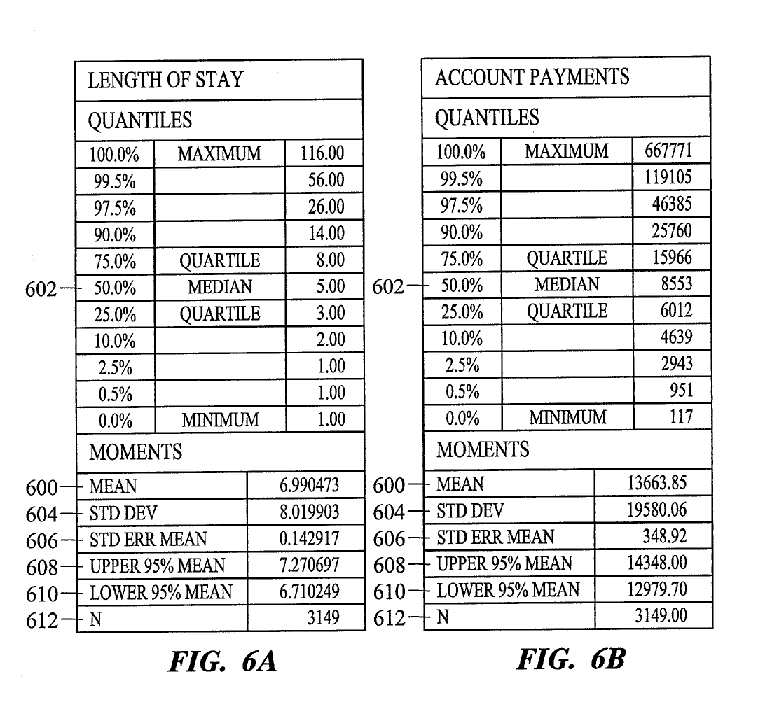

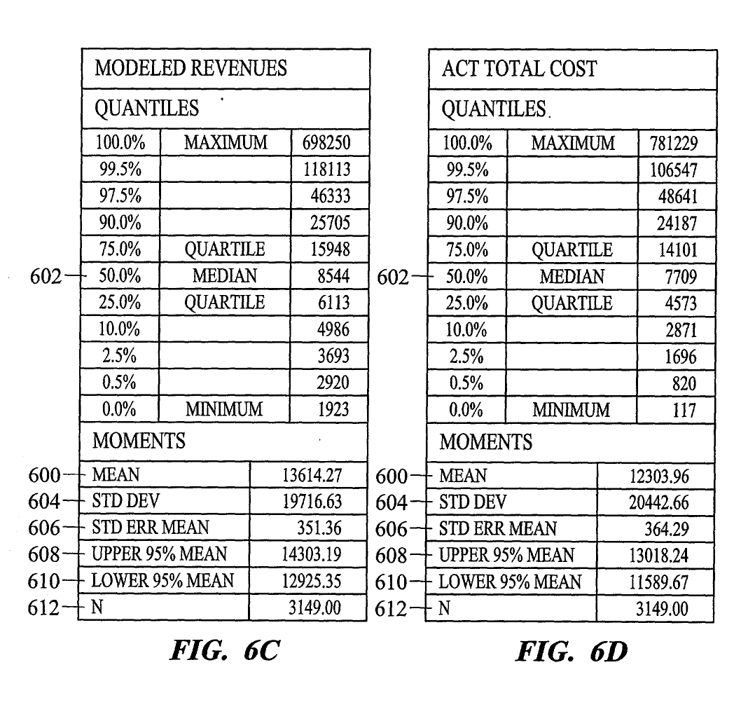

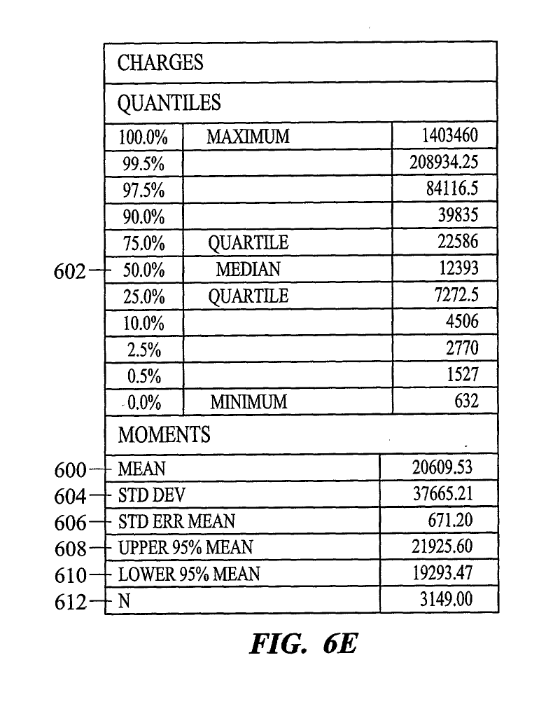

FIGS. 6A-6E illustrate conventional statistical measures performed for some of the fields described with respect to FIGS. 3A and 3B. For example, FIG. 6A is a table that includes mean 600, median 602, standard deviation 604, standard error of the mean 606, data within a predetermined upper 608 and lower 610 range of the mean, minimum, maximum, and number of samples 612 for length of a patient's stay in a healthcare facility. FIG. 6B is a table that includes the same measures 600-612 for account payments for healthcare services provided. FIG. 6C is a table that includes the same measures 600-612 for modeled revenues. As stated above, revenues can be modeled using a commercially available program such as CHARGEMASTER® or a model can be created in-house by a healthcare provider. FIG. 6D includes statistical measures 600-612 calculated for account total costs. In the healthcare industry, such costs include cost associated with facilities, equipment, service provider fees, etc. FIG. 6E illustrates conventional statistical measures 600-612 calculated for charges for healthcare services provided.

The conventional statistical measures illustrated in FIGS. 6A-6E may be calculated using any commercially available statistical analysis software such as the JMP® program or using a spreadsheet, such as the Microsoft EXCEL® spreadsheet. These measures have been conventionally used to improve financial processes. However, conventional statistical analysis stopped with these measures. The methods and systems for identifying attributable errors in financial processes depart from this simple summation of the data and apply advanced statistical tools to identify and quantify causal factors responsible for statistical variance.

### Analysis of Data Variance by Category

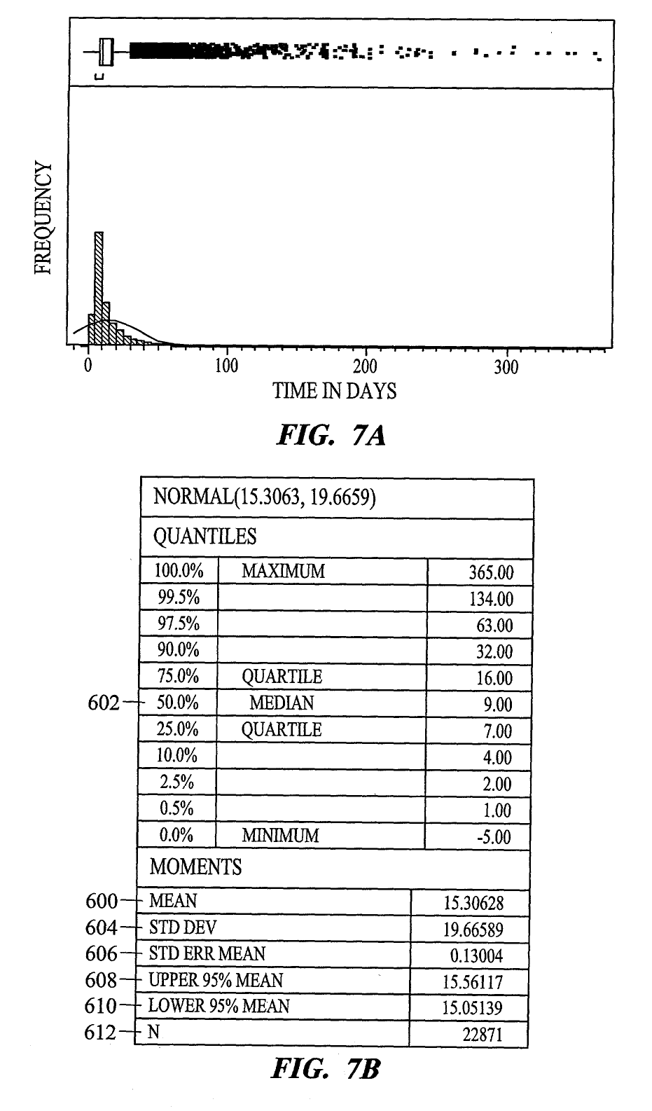

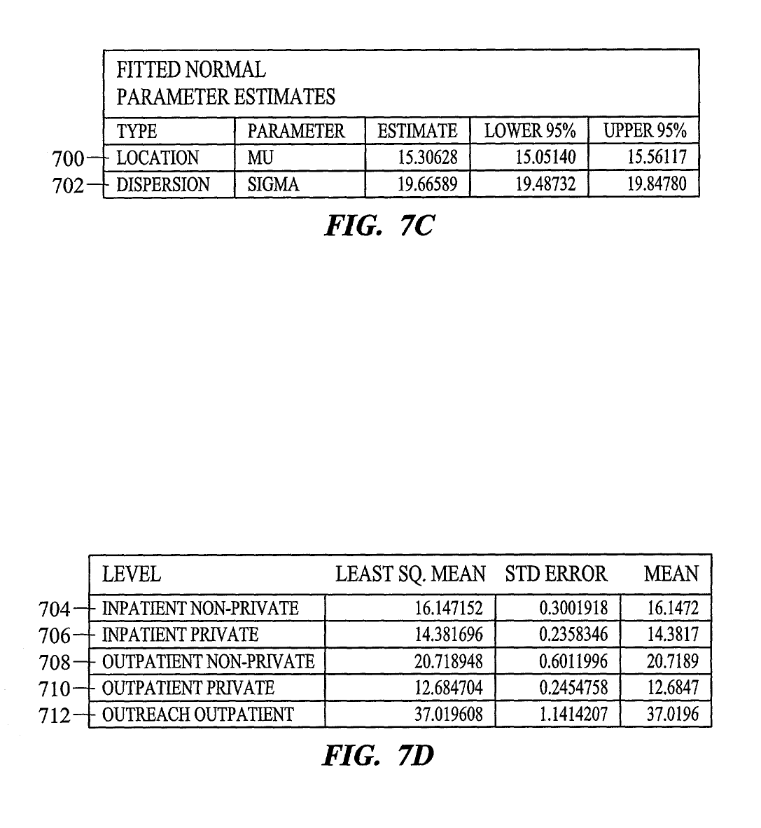

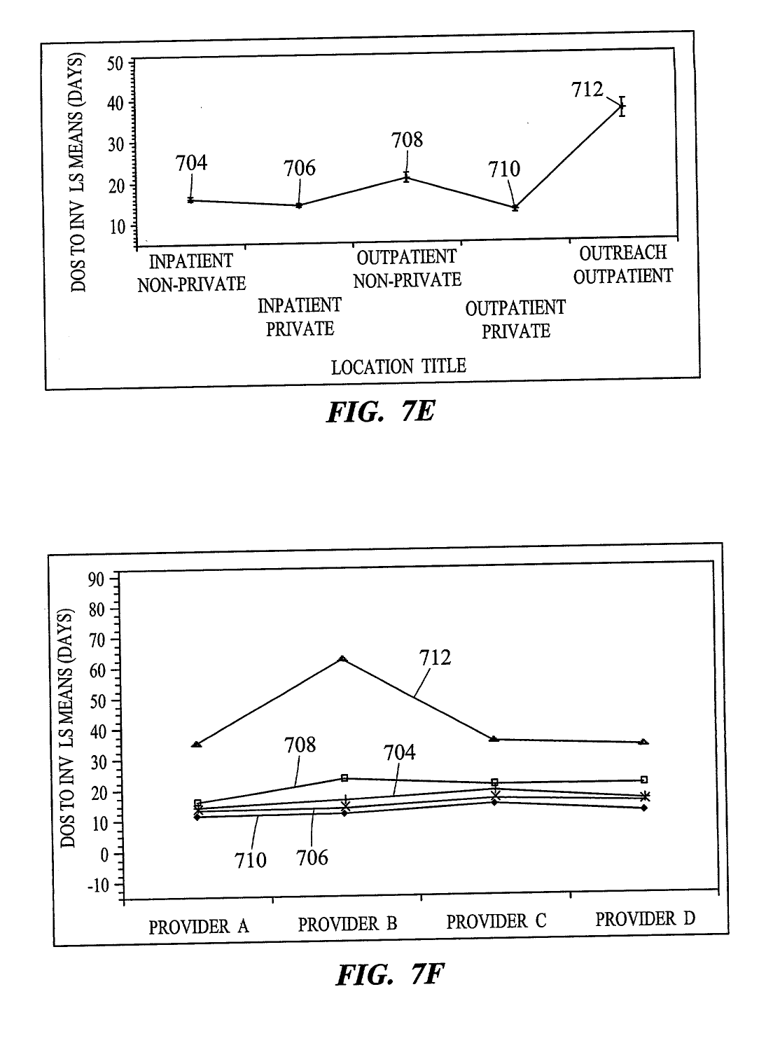

The first step in identifying causal factors responsible for statistical variance is visual inspection of the data. FIG. 7A is a graph and FIGS. 7B and 7C are tables corresponding to a visual plot of the time between date of service and mailing of an invoice for the service. More particularly, FIG. 7A is a histogram illustrating a frequency distribution of the time between date of service and invoice. FIG. 7B is a table containing conventional statistical measures for the measured data in FIG. 7A. Finally, FIG. 7C is a table illustrating the fit between the curve in FIG. 7A and the actual data. Parameters used to illustrate the fit are location 700 and dispersion 702. Location 700 indicates the location of the mean of the fitted curve in FIG. 7A. Dispersion 702 indicates the variance for the fitted curve.

It will be appreciated from FIGS. 7A-7C that the distribution is non-Gaussian or non-normal and unsuitable for analysis using conventional statistical measures 600-612 illustrated in FIG. 7B. This distribution is often described as a beta function and can be roughly approximated by a log transformation of the data. Rather than using the conventional statistical measures such as means and medians, the methods and systems for identifying attributable errors in financial processes either visually inspects the data or uses a test, such as the Kolmogorov-Smirnov-Lilliefors (KSL) test, for normalcy to identify data as non-normally distributed. The KSL test may be used for values of n (# of samples) greater than 2000. The Shapiro-Wilk test may be used for values of n<2000. The reason for performing this identification is that non-normally distributed data may represent significant contributing factors associated with process variance.

Once the data is identified as non-normally distributed through either visual analysis or through application of the KSL test, analysis of variance techniques can be used to identify factors that can have a significant effect on an observed process. FIGS. 7D and 7E illustrate the application of an analysis of variance technique to identify factors that can contribute to variance in the date of service invoice example illustrated in FIGS. 7A-7C. FIG. 7D is a least squares means table and FIG. 7E is a least squares means plot for time from date of service to invoice for different healthcare provider locations. More particularly, FIGS. 7D and 7E include least squares means times for inpatient non-private 704, inpatient private 706, outpatient non-private 708, outpatient private 710, and outreach outpatient 712 locations. It can be seen from both FIGS. 7D and 7E that outreach outpatient location 712 has the highest least squares mean time from date of service to invoice. It can also be seen that most of the service locations have a least squares means with similar processing times, i.e., least squares means less than 21 days. Although the difference for outreach outpatient services may represent actual site-to-site differences, the presence of particular providers may further influence the timeliness of bill preparation. To examine this possibility, a nested analysis of variance is subsequently performed on the data set for particular providers, i.e., different physicians.

FIG. 7F is a graph illustrating date of service to invoice least squares means for four different providers, labeled ‘Provider A,’ ‘Provider B,’ ‘Provider C,’ and ‘Provider D.’ In FIG. 7F, each line in the graph represents the timeliness of bill processing based on locations 704-712 analyzed separately in FIGS. 7D and 7E. The divisions on the horizontal axis of the graph represent each provider's timeliness in bill preparation in each location. Lines 704-712 represent the service locations, as previously described. It can be seen from the uppermost line in the graph that outreach outpatient location 712 has the longest time for charge processing. It can also be seen from the graph that provider B takes the longest time to process bills, particularly for outreach outpatient services. Thus, the nested analysis of variance according to the methods and systems for identifying systematic errors in financial processes according to the present invention has identified that both location and provider may have an effect on timeliness of bill presentment. Accordingly, financial managers at a particular institution might direct their efforts towards improving system processes in the outreach patient area as well as educating the particular provider, i.e., Provider B, with the billing processes.

### Analysis of Data Variance by Contributing Factors

In considering contributing sources of error or variance from modeled values detected by the present invention, the most likely factor(s) responsible for systematic variance will be related to the mathematical design of the revenue model, with factors associated with the implementation of the revenue process, or with third party payment errors. In this connection it should be appreciated that the successful application of the invention will therefore require a database containing sufficient and accurate information to calculate anticipated revenues, timeliness of payments and source of payors.

With this in mind, the following analyses are conducted on a representative Medicare database comprised of a set of actual payments, modeled revenues, diagnostic related groups (DRGs), and service dates. Diagnostic related groups are groups of accounts having the same or a similar medical diagnosis or service, e.g., heart transplant. The revenue methods used to calculate the base revenues for both actual payments and modeled revenues are based on a payment-weighted model (DRGs). In this illustrative case, it should be noted that the revenue model predicts the minimum of expected payments but that the actual account payments may be higher than this minimum if there are supplemental payments made to the account. As discussed previously, the first step in the process examines the data with respect to their distribution and simple econometrics.

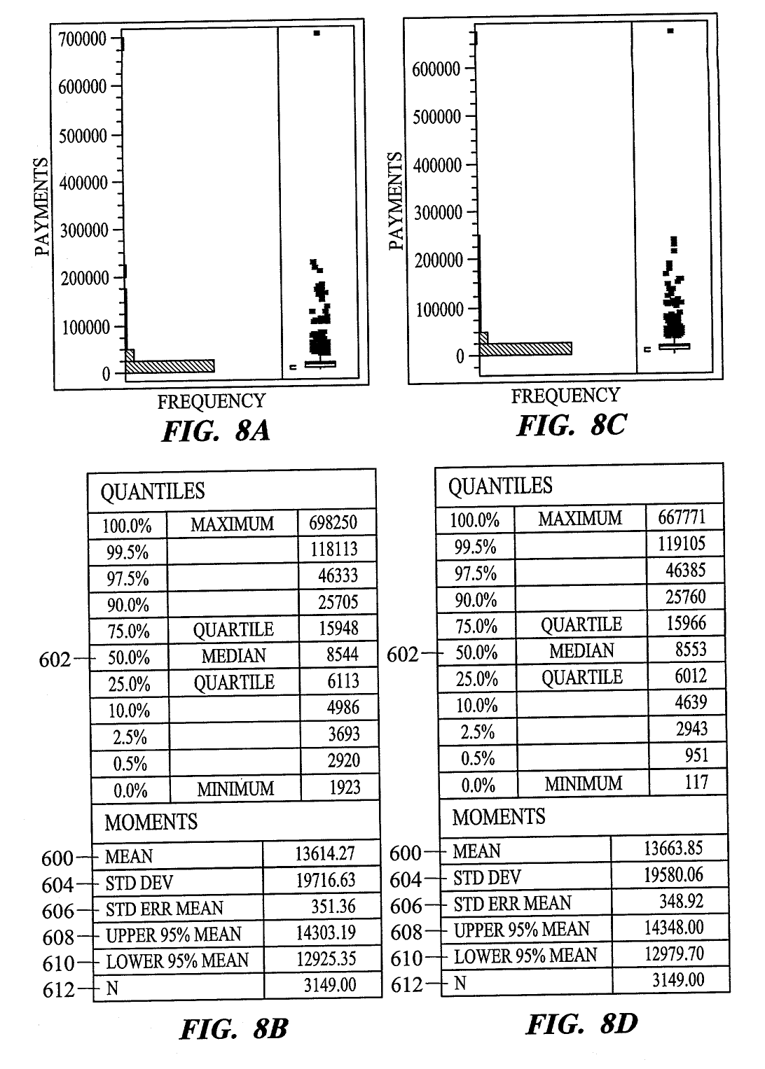

FIGS. 8A-8D illustrate the application of simple econometrics including conventional statistical measures for actual and modeled revenues for the Medicare database. More particularly, FIGS. 8A and 8B are respectively a histogram and a table containing the distribution of modeled revenues for the Medicare database. FIGS. 8C and 8D are respectively a histogram and a table illustrating the distribution of actual payments from the Medicare database. It can be seen from FIGS. 8A-8D that the modeled and actual revenues are similar with respect to median values 602, mean values 600, and overall distribution of payment activity, i.e., quantile distributions. Thus, from these conventional measures, the model appears to be accurate. However, as will be discussed in more detail below, systematic errors exist in the data and the method steps of the present invention can be used to identify and determine causes for these errors.

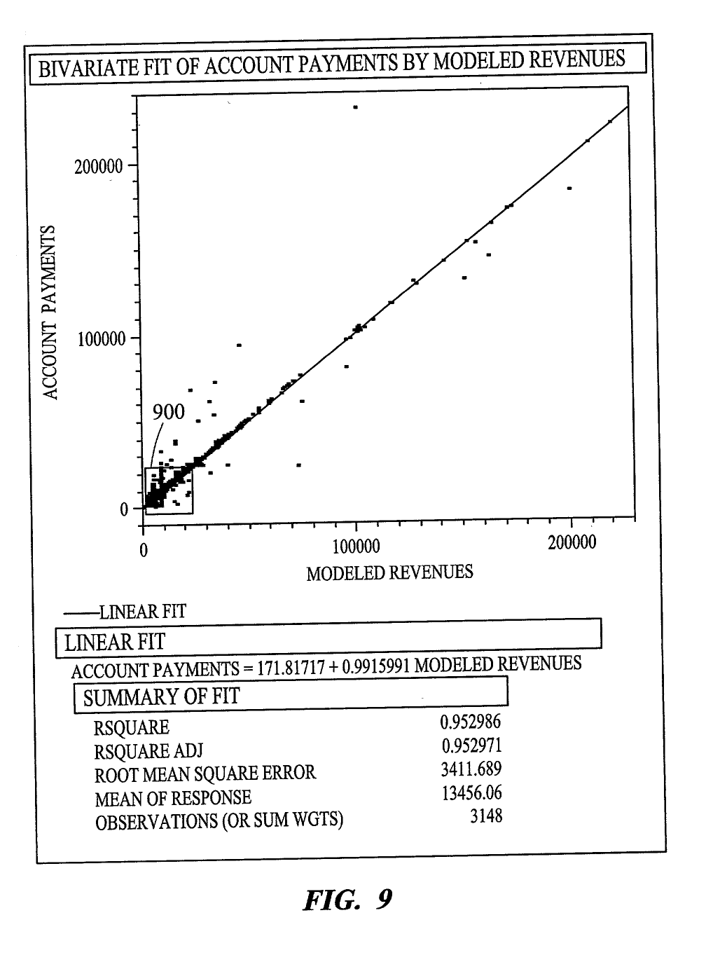

FIG. 9 is an example of an application of visual statistics to determine variance between actual and modeled revenues for the Medicare example. More particularly, FIG. 9 is an X-Y plot where modeled revenues are presented on the X-axis and actual account payments are presented on the Y-axis. If actual revenues perfectly match modeled revenues, the result would be a diagonal line with a slope of 1.

As can be seen, the relationship between modeled revenues and account payments is generally linear with the preponderance of data points clustered near the origin of the X-Y plot. Statistical analysis of this graphic begins with linear regression which is a statistical tool used to indicate the degree of correlation between two continuous variables. As seen in FIG. 9, although there exists some scatter of the data around the regression line of fit, regression analysis indicates that the model is an excellent predictor of actual payments (r²=0.953, slope=0.992).

The next step in the process involves a closer examination of the data in high-density region 900 near the origin of the X-Y plot illustrated in FIG. 9. This next step is warranted because the visual inspection of the data plot suggests that the variance around the regression line may greater near the origin of the X-Y plot. High-density region 900 can be magnified using conventional statistical analysis software such as the above-referenced JMP® program. In order to magnify region 900, the user selects a magnification tool and encloses the data points that the user to magnify using the magnification tool.

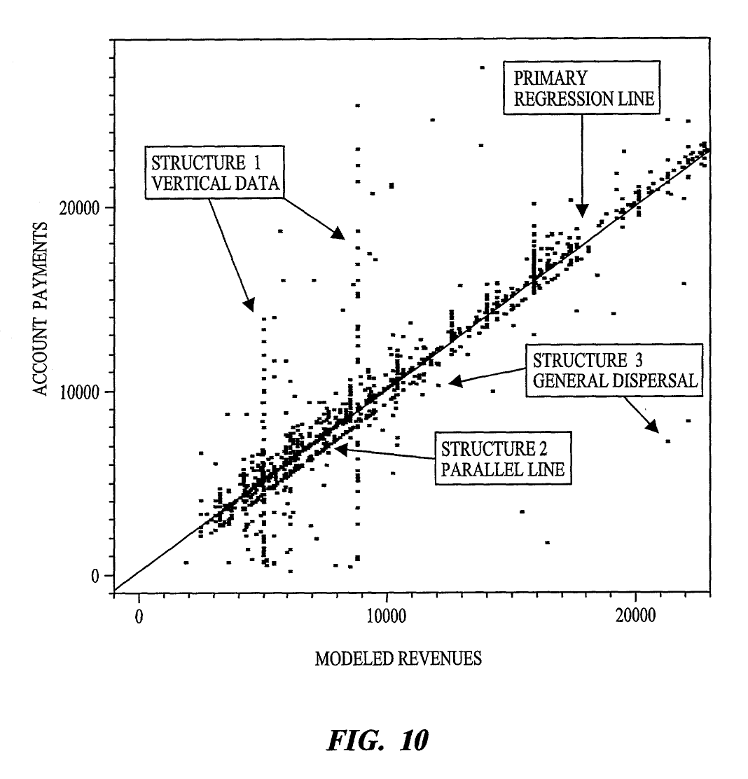

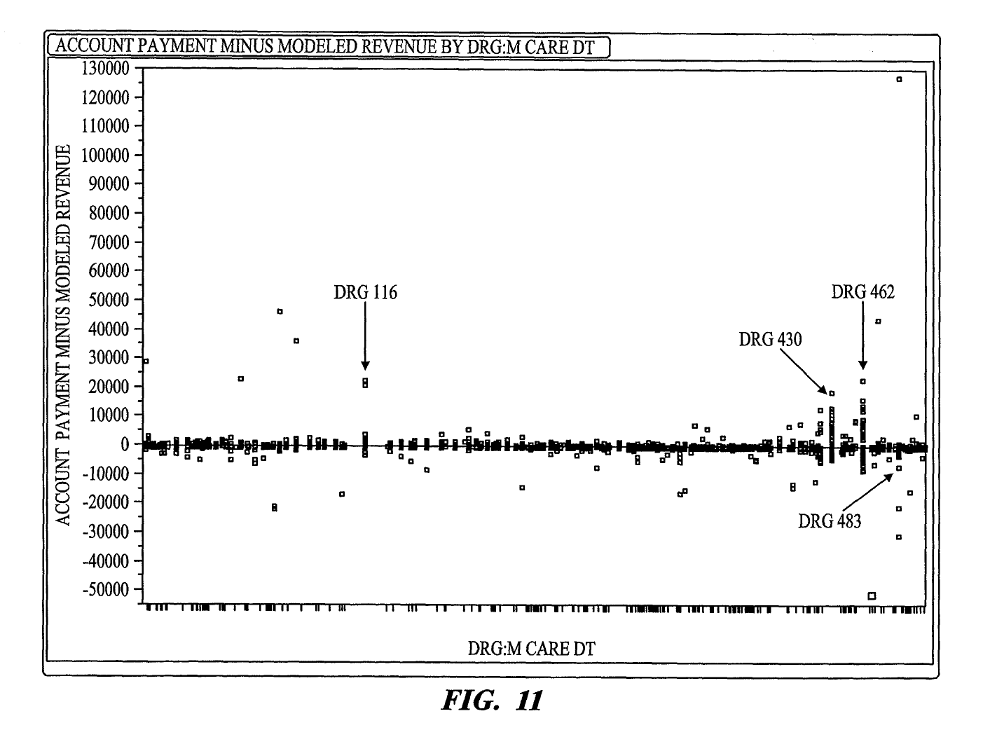

FIG. 10 illustrates the result of magnifying area 900 using the magnification tool. In those statistical programs lacking a ‘magnification tool,’ a suitable alternative would be to simply re-scale the respective X-Y axes. As can be seen in FIG. 10, variance (or degree of departure) from the previously drawn linear regression line is more noticeable. Of interest is the appearance of several ‘structures’ contained within the graphically displayed data. The first structure, structure 1, is the vertical array of actual payments along a single modeled revenue value. A second, easily discernable structure, structure 2, is a line running just below and parallel to the computer-derived linear regression line. A third structure, structure 3, is depicted by a general dispersal of the data around the regression line. In this connection it should be noted that a fourth structure consisting of data points forming a horizontal line (i.e., parallel to the X-axis) is also possible but is not seen here. In this fourth case, while the model might predict a range of payments the actual payments are fixed. This typically occurs when the actual process is DRG-based (i.e., single payment based) but that the model was incorrectly designed (e.g., on a fee for service basis). In the present example, the model correctly reflects the actual DRG-based payment basis for payments-as a result, this fourth structure of payments is absent.

Analysis of the remaining data structures 1-3 begins with a review of what is known: first, modeled revenues are DRG-based; second, actual payments can be the sum of both DRG-based payments and a variable amount of supplemental payments; and third, some DRGs are paid on length of service rather than lump sum basis. The vertical alignment of many actual payments in excess of modeled revenue (the portion of structure above the regression line) indicates the presence of supplemental payments made in addition to the DRG payments (i.e., modeled revenues). Actual payments less than model prediction (the portion of structure 1 below the regression line) may represent either payment or model error. To assess these latter considerations, a subset of the data in structure 1 is created which encompasses all payments less than expected. Using this newly developed subset of the data, a new data column is created using statistical analysis software 128 representing the difference between the actual payments received versus the modeled revenues. To the extent that payments are expected to be DRG-based, any deviation from this expected pattern can be quickly identified by simply plotting the difference in payments with respect to the model revenues versus their respective DRGs.

This analysis is seen in FIG. 11. FIG. 11 is a graph of account payments minus modeled revenues for DRGs 116, 430, 462, and 483. In FIG. 11, the vertical access represents account payments minus modeled revenues for structure 1 illustrated in FIG. 10, which should ideally be zero. The horizontal axis represents different diagnostic related groups. In other words, data points along a vertical line represent difference values for a particular DRG. For clarity, only DRGs 116, 430, 462, and 483 are labeled.

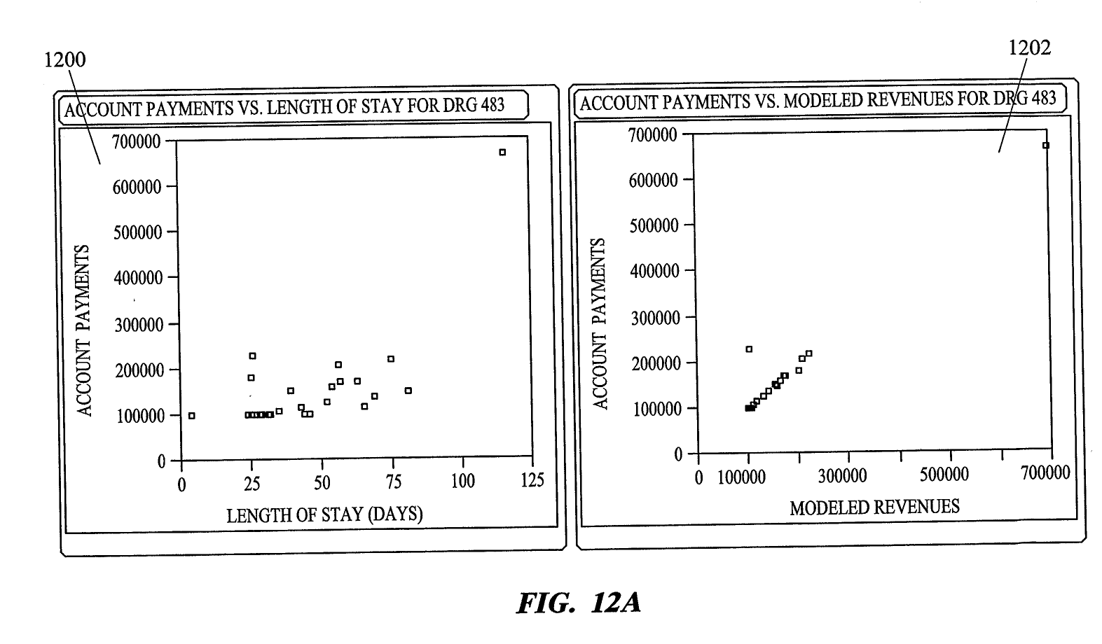

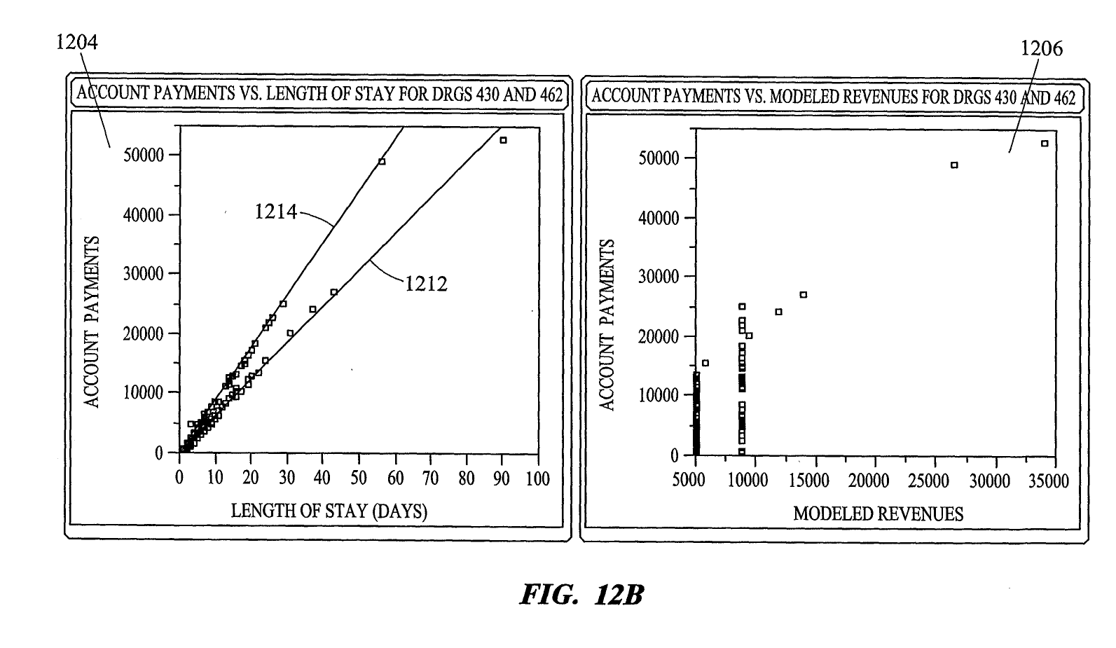

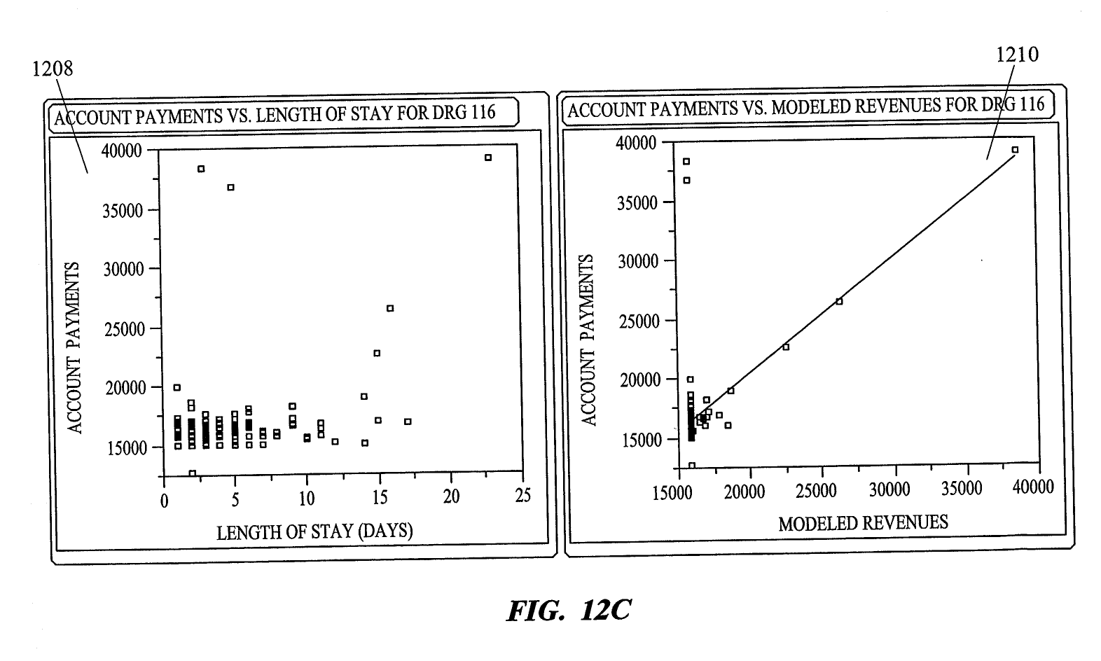

From FIG. 11 it can be seen that DRG 116, DRG 430, DRG 462, and DRG 483 (tracheostomy) are characterized by a wide range of payments that are inconsistent with the DRG-based methodology of payment. (Payments for the same DRG should be the same.) Further analysis of these DRGs is illustrated in FIGS. 12A-12C. More particularly, FIG. 12A includes a first graph 1200 of account payments versus length of stay and a second graph 1202 of account payments versus modeled revenues for DRG 483. FIG. 12B includes a first graph 1204 of account payments versus length of stay and a second graph 1206 of account payments versus modeled revenues for DRGs 430 and 462. FIG. 12C includes a first graph 1208 illustrating account payments versus length of stay and a second graph 1210 illustrating account payments versus modeled revenues for diagnostic-related group 116. As can be seen from FIG. 12A for DRG 483 (tracheostomy), LOS is not a good predictor of account payments whereas modeled revenues, with the exception of a single data point, appear to be predictive of account payments. However, upon closer examination of this particular DRG's slope and it's deviation from the expected slope of 1.0, it is noted that although there is good agreement between account payments and the model, the model consistently underestimated the actual payments by 8%. This consistent underpayment would be an indication that further inquiry into the payment of DRG 483 is warranted.

Referring to FIG. 12B, in contrast to DRG 483, payments for DRGs 430 (line 1212) and 462 (line 1214) are LOS, not DRG based, as evidenced by their linear relationship with respect to LOS. Moreover, the slope of the lines suggest that DRG 430 (Psychoses) is reimbursed at about $561/pt day whereas DRG 462 (Rehab) is reimbursed at $885/pt day.

Finally, referring to FIG. 12C, analysis of DRG 116 demonstrates the effect of supplemental payments, which can contribute to variance with modeled revenues. Here, LOS has no predictive value whereas the model is in generally good agreement with account payments. The variance (or departure) from the model can be accounted for by the presence of supplemental payments.

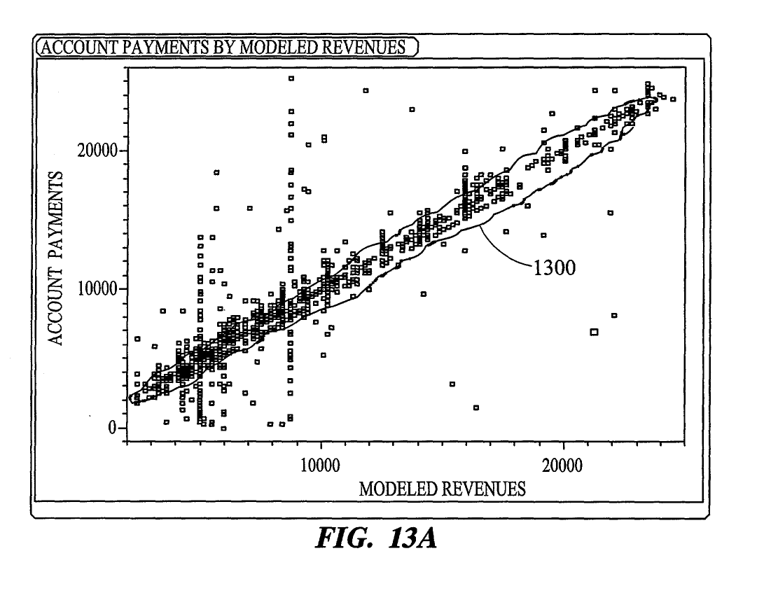

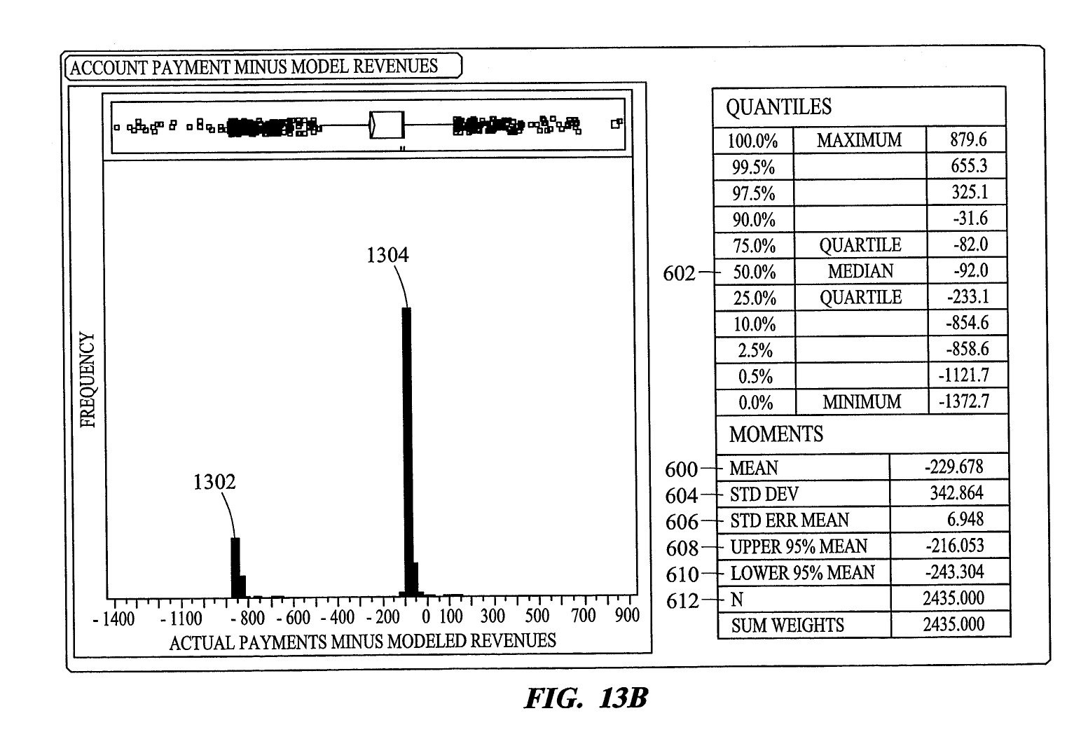

Analysis of data structure 2 (see the line parallel to the regression line) illustrated in FIG. 11 again begins with isolation of the data. Such isolation can be accomplished using the “lasso” tool available in some statistical analysis software, such as the JMP® program. FIG. 13A is a graph of the same dataset, illustrated in

FIG. 11 (account payments versus modeled revenues for the Medicare database) where the JMP® lasso tool is used to isolate data structure 2 (parallel lines) illustrated in FIG. 11. In order to use the lasso tool, the user selects the lasso tool and draws a line or curve around the data of interest. In FIG. 13A, curve 1300 is intended to capture data structure 2 illustrated in FIG. 11. Once the user draws the line around the data structure, the JMP® software automatically isolates this data for further analysis.

FIG. 13B is a simple histogram plot of actual payments-modeled revenues for the isolated data in FIG. 13A. Two patterns of payments are now clearly discernable with their ‘peaks’ 1302 and 1304 separated by approximately $760. The number of accounts comprising each of these data ‘peaks’ 1302 and 1304 can be easily determined by creating additional subsets comprised of each peak. In this case, approximately 500 cases are contained within the smaller ‘peak’ 1302 whereas about 1500 accounts are contained within the taller ‘peak’ 1304. Those familiar with DRG-based payments will readily understand that the $760 difference between the ‘peaks’ closely approximates the insurance deductible for Medicare. In Medicare, each insured patient has to pay a one-time annual deductible of about $760. Once the deductible is paid, Medicare insurance pays using one of the above-described methods, such as DRG or length of stay-based methods. Thus, if every patient coming to a hospital had already paid his or her Medicare deductible, the hospital could be expected to be paid by Medicare on a DRG or length of staybased model. However, there is no way of determining whether a patient has paid the deductible and consequently there is no way to determine a hospital will actually receive the deductible. In the example illustrated in FIG. 13B, the model overestimates the number of patients that have paid the Medicare deductible. Of interest, it should be noted that in the present example, the modeled revenues in FIG. 1 3B systematically overestimate actual revenues 25% of the time (i.e., 500/(500+1500)). In companies using accrual-based financials, this overestimation of revenues based on model prediction could have deleterious consequences.

Fortunately, by applying these analytical tools, it is now possible to assess the relative risk of this uncompensated pool (i.e., the insurance deductible) as a function of time by simply examining the ratio on a quarterly or yearly basis. For example, the number of patients treated who have not paid the deductible can be periodically calculated and the revenue model can be changed to predict actual revenue more closely. Finally, it should be noted that the tallest ‘peak’ 1304 does not fall on zero, rather the ‘peak’ falls at a minus $100. Ordinarily, such a small discrepancy when viewed in the context of an average payment of $6,000 would go unnoticed (i.e., a variance of 100/6000 or 1.7%). However, To the extent that the factors comprising the modeled revenue calculations are accurate, it is possible to determine which factor(s) are most likely responsible for the majority of this negative variance. In this case, each factor was separately entered as a candidate for the cause for the variance. Factorial analyses of the data elements indicated that a calculation error in either one of two revenue factors was most likely responsible for the small ($100) negative variance. If one of the two factors is related to error on the part of the payor, lost revenue can be reclaimed.

Referring back to FIG. 11, data structure 3 contains elements both above and below the regression line that have no discernible pattern. Analysis of data elements which may lie above or below the primary regression line and which have no easily discernable pattern represent a particular challenge. As a general rule, these data elements may represent scattered systematic error or more may simply represent residual random error inherent in any system.

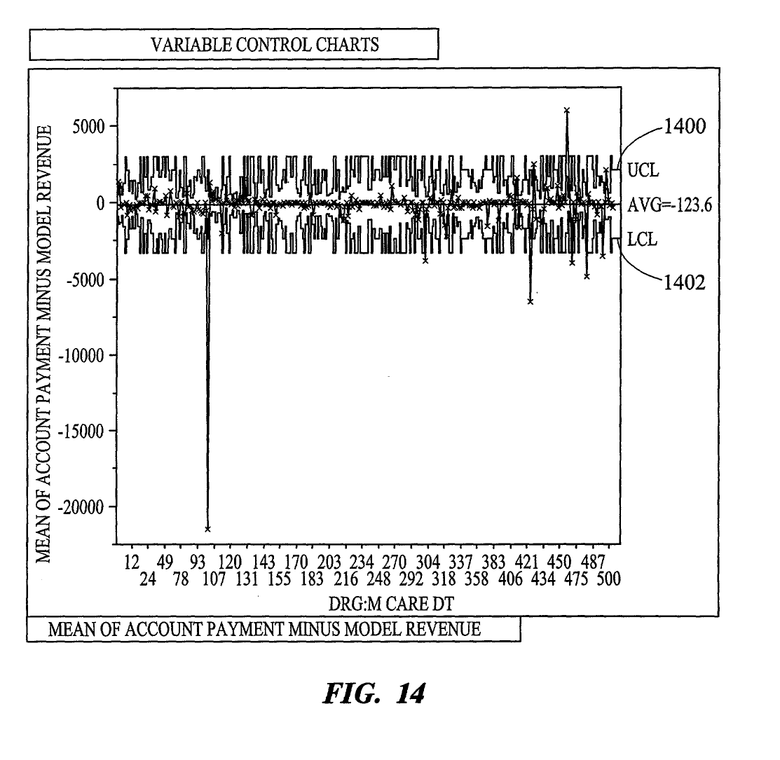

The analysis of the underpayment data begins with a re-sorting of the data table with respect to the DRG. Once properly arranged, the data set will contain the DRGs grouped together in either an ascending or descending order (the particular order is not important). The invention then turns to the use of a control charting technique to identify DRGs which are deviating significantly from the group norm. FIG. 14 is a control chart illustrating the difference between actual and modeled revenue for data structure 3 wherein data points for the same DRGs are grouped together, i.e., in the same vertical line. Upper boundary 1400 represents an upper confidence limit for the difference between actual and modeled revenue payments for each DRG while lower boundary 1402 represents a lower confidence limit for each DRG. As seen from FIG. 14, some DRGs have accounts that differ substantially from the model. Accounts that deviate significantly greater than as well as less than the model can be identified.

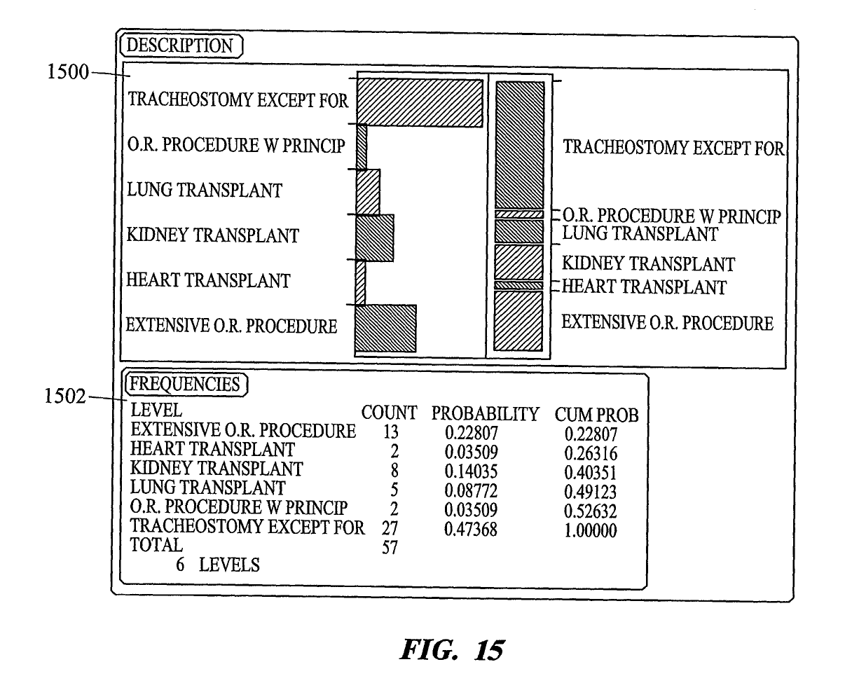

To determine the most likely cause(s) associated for the deviation of DRGs found below the group's lower confidence limit (i.e., LCL), another subset of the data is created by simply ‘lassoing’ those points that are found below the LCL and create a subset of data from those identified groups. The distribution of those identified groups can be seen in FIG. 15. More particularly, upper portion 1500 is a graph (histogram) and lower portion 1502 is a table created using statistical analysis software 128 for revenue differences below lower limit 1402 on a DRG basis. In FIG. 15, six separate DRGs were found to have significantly less revenues than were predicted by the model. Since the deviation from the model of DRG 483 (tracheostomy) has already been considered, that particular DRG can be removed from the subsequent analysis.

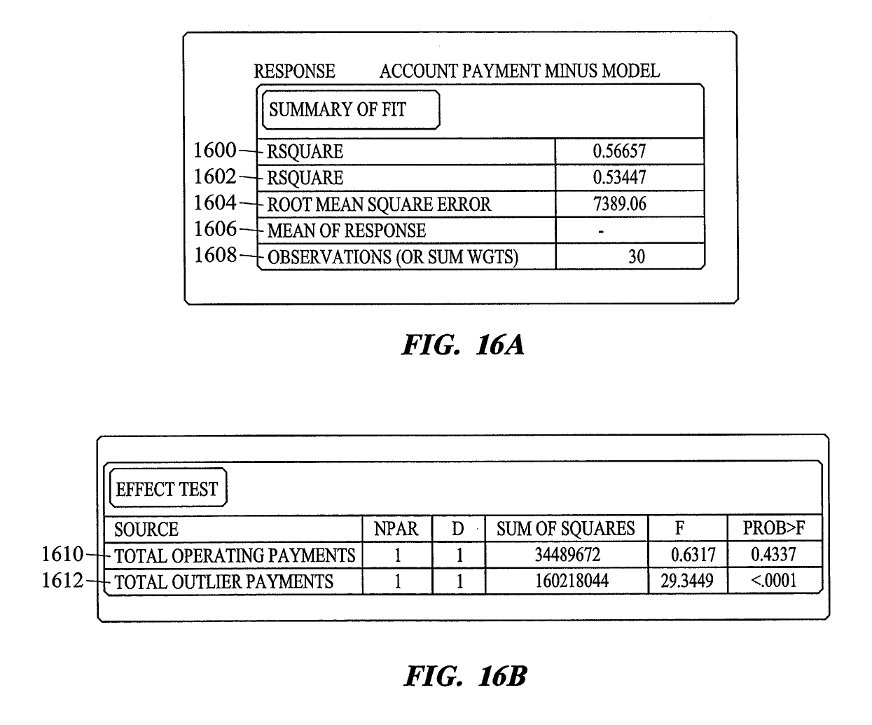

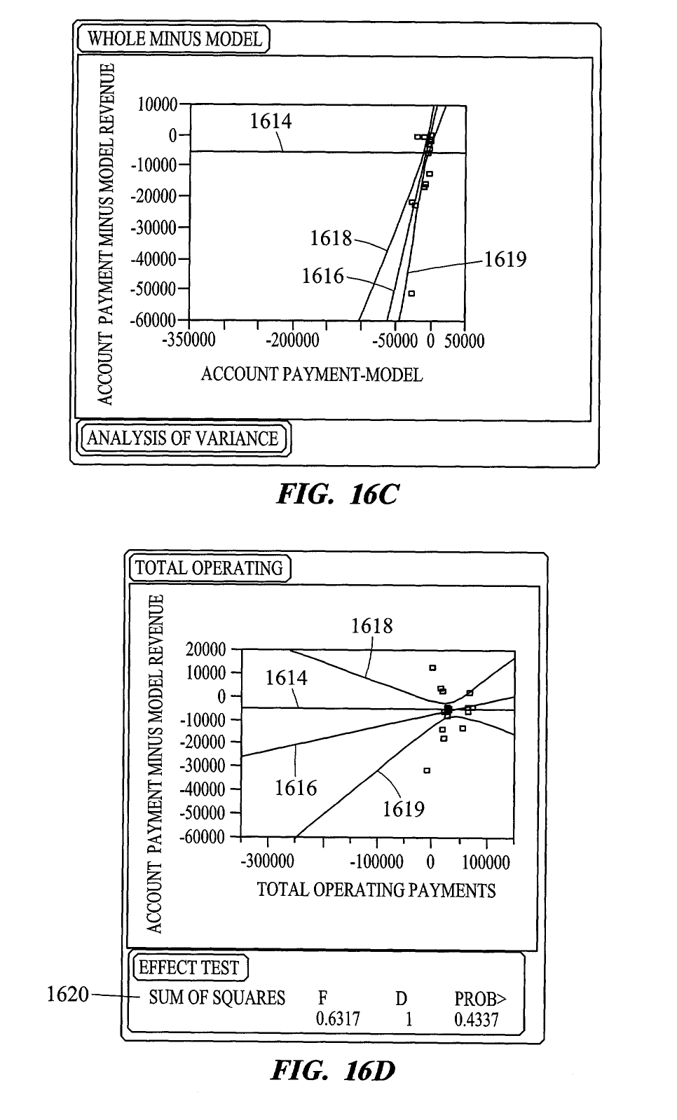

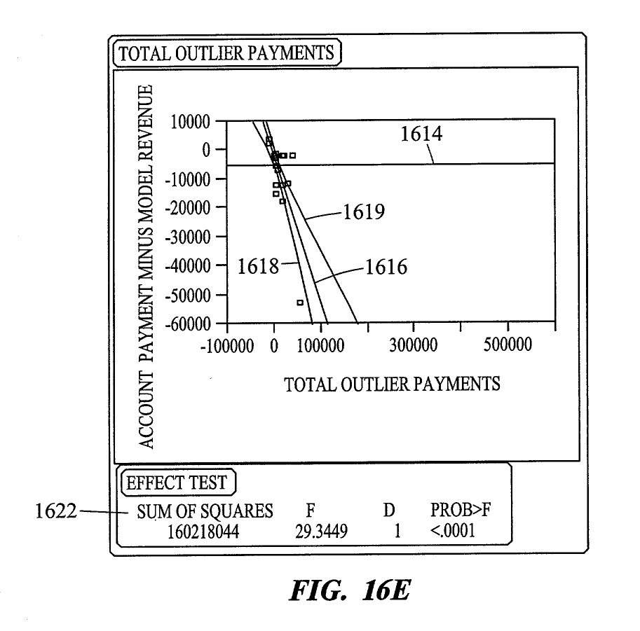

The analysis of the remaining data begins with the deconstruction of the DRG revenue model into its two primary components: 1) operating or DRG-based payments; and 2) outlier payments. In Medicare, operating payments represent the amount paid based on diagnosis alone. Outlier payments represent the amount paid for excessive services rendered. Since either factor could contribute to a revenue shortfall, it may be desirable to eliminate one or both as a potential cause for the shortfall. Such analysis is referred to as factorial analysis and will be described in detail with respect to FIGS. 16A-16E.

To the extent that the operating DRG-based payments are collinear with respect to the DRG assignment, one of the factor elements used for this analysis can simply be the DRG itself. The other factor, total outlier payments, constitutes a second model element. A two-factor model is constructed using the JMP® program ‘fit model’ feature. In this analysis, the quantity representing the variance (i.e., account payments—modeled revenues) is assigned as the ‘Y’ factor. The two primary factors are assigned as ‘X’ factors (i.e., the candidates responsible for the observed variance). In this connection, those familiar with the art will recognize that the number of factors which can be analyzed is not limited to only two elements and that interactions between the factors can be separately examined by using this approach.

The results of the factorial analysis on the remaining DRGs from FIG. 15 are depicted in FIGS. 16A-16E. FIG. 16A is a table generated by statistical analysis software 128 summarizing the fit between the actual difference in account payments and modeled revenues and the model for the difference between account payments and modeled revenues for the two factors mentioned above. In particular, FIG. 16A includes a first r² value 1600 indicating the variance between actual revenue difference and the model. Second r² value 1602 is the adjusted variance for the number of measurements taken, which in the illustrated example is 30. Root means square error value 1604 indicates the RMS value of the variance. Mean of response value 1606 was not generated because of the low number of samples. Finally, observations value 1608 indicates the number of samples used in the calculations. The summary data illustrated in FIG. 16A indicates that the two factors (total operating revenues and total outlier payments) can account for 53% of the model's variance (r²=0.53). Thus, it is necessary to determine whether either one of the values can be eliminated as a cause of the variance.

FIG. 16B is a table illustrating the summary of the effect test for the model. The effect test is a statistical test that indicates whether the probability that a given factor caused the variance is due to chance. In general, if the probability of the factor causing the variance is due to chance is greater than 0.05, then this factor can be eliminated as a potential cause. In FIG. 16B, the factors are total operating payment 1610 and total outlier payment 1612. The column labeled “PROB>F” indicates whether the probability that each factor caused the variance is due to chance. In the illustrated example, probability for total operating payments is .4337, which is greater than 0.05. Hence, total operating payments can be eliminated as a factor that caused the variance. The probability for total outlier payments, on the other hand, is less than 0.0001, which is less than 0.05. Hence, total outlier payments may have a causative relationship with the variance. Total operating payments can be eliminated as a factor.

FIGS. 16C-16E are graphical representations that can be used to obtain the same results obtained from the summary data in FIGS. 16A and 16B. More particularly, FIG. 16C is a graph of actual versus modeled differences between account payments and modeled revenues taking into account both factors. Line 1614 in FIG. 16C is the modeled mean difference value. Line 16 is the modeled regression line. Lines 1618 and 1619 are the upper and lower 95% confidence intervals for mean line 1614. The data points represent the actual values. From the graph in FIG. 16C, because the data points are closely approximated by regression line 1616, the combination of total operating payments and total operating costs has an effect on variance.

FIG. 16D is a graph of the difference between actual and modeled revenues for total operating payments taken alone. In FIG. 1616, many of the data points are outside the upper and lower confidence intervals 1618 and 1619. In addition, the confidence intervals do not cross mean line 1614. Because confidence intervals 1618 and 1619 do not cross mean line 1614, total operating payments can be eliminated as a factor that has a potential causative effect on variance. The bottom portion 1620 of FIG. 16D illustrates the results of the effect test for total operating payments as described with respect to FIG. 16B.

FIG. 16E is a graph of the difference between actual and modeled payments for total outlier payments taken alone. From the data points in FIG. 16E, it can be seen that the difference between account payments and modeled revenues increases as total outlier payments increase. In addition, because upper and lower confidence lines 1618 and 1619 cross mean line 1614, total outlier payments have an effect on variance. Finally, lower portion 1622 of FIG. 16E illustrates the results of the effect test for total outlier payments described above with respect to FIG. 16B. In summary, from 16A-16E, the organization performing the investigation should determine why total outlier payments are not being paid as expected. Total operating payments can be eliminated as a potential cause for the difference between actual and modeled revenue payments.

### Advanced Time-Based Analysis of Financial Data

In addition to the direct and indirect costs associated with the provided services, there are time-sensitive costs associated with the recovery of revenues from third parties or with the performance of other time-based processes. The time from date the service to date of payment can vary widely between payors and even within payors with respect to the kinds of service provided. Comparison of the ‘timeliness’ of payments between payors is further hampered by the non-parametric nature of the data (that is, the data are not normally distributed) rendering common statistical analyses of averages or means inconclusive.

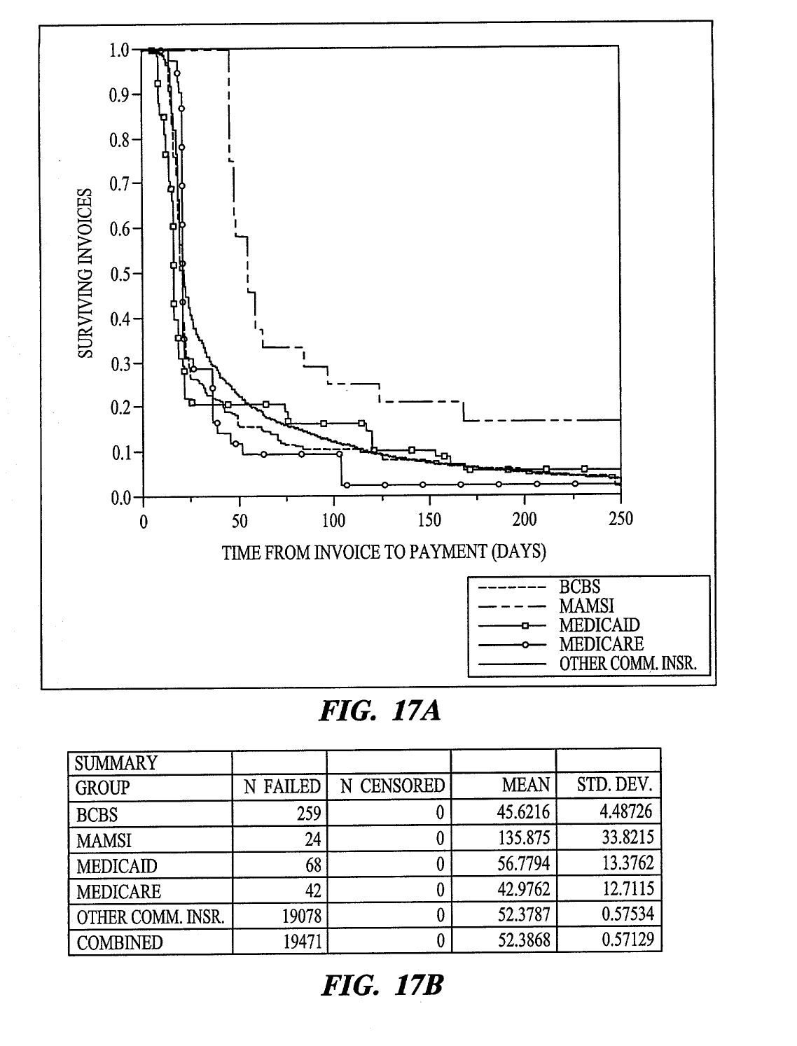

The present invention addresses this latter limitation by analyzing time-based data and their potential competing factors with a novel application of the Kaplan-Meier survival statistic. Those familiar with the art will appreciate that this latter statistic was developed for use in cancer medicine to compare the relative strengths of different treatment protocols on survival outcome. In the present invention, this survival statistic permits examination of the relative performance of time-based processes and compares those performances with either a reference standard or with categorical elements within the given data set. A representative example of this approach is depicted in FIGS. 17A and 17B. More particularly, FIG. 17A is a Kaplan-Meier survival graph and FIG. 17B is a summary table illustrating the differences in payment times for various insurers.

In the graph in FIG. 17A, the vertical axis represents the percentage of surviving invoices. The horizontal axis represents the number of days. Each of the curves in FIG. 17A represents invoice survival for a particular company. An invoice is treated as being ‘born’ when it is mailed, and the invoice is treated as ‘dying’ when it is paid. This is a novel application of the Kaplan-Meier statistic, which is conventionally used to determine the survival rate of cancer patients treated by different drugs.

In FIGS. 17A and 17B, the number of days required to process payments for four representative insurance companies (BCBS, MAMSI, Medicaid, Medicare) are compared to all payors (depicted in FIGS. 17A and 17B as ‘other commercial insurers’). Unlike traditional econometric depictions of these data, time-based differences between these companies can be readily appreciated and their performance vis a vis each other and all similar payors can be easily visualized. In addition to these comparisons, the approach provides important information regarding the timing of payments made by each company. As seen in FIG. 17A, the onset of payments can vary widely between companies. To those familiar with the art, this latter assessment represents a major contributory factor to the ‘float’ and can significantly increase the cost of business. In this connection, it can be further readily appreciated by those familiar with the art that the relative cost associated with the ‘float’ or tardiness of payments can be calculated by knowing the total outstanding accounts receivable submitted by each company togetherwith their percentage of their outstanding account as a function of time. Knowledge of these ‘hidden’ costs associated with each contract at the payor or even sub-plan level provides contract negotiators with valuable information during contract renewal discussions.

It will be understood that various details of the invention may be changed without departing from the scope of the invention. Also, it should be understood that the elements of the invention, although shown separately for clarity, may be performed in an integrated and automatic manner through the appropriate use of a scripting language, such as an OBDC scripting language. In this way, the statistical analyses as described herein may be performed on a recurrent or recursive basis on data sets that are inherently fluid with respect to the financial data that they contain. For example, the process steps described above may be implemented as a computer program written in a script language that periodically accesses a dataset and generates a periodic ‘report card’ containing any one of the data output formats mentioned above. The user could then use the statistical analysis methods described herein to determine the causes of significant variance from expected values. This step could also be automated using a computer program written in a scripting language, for example. Furthermore, the foregoing description is for the purpose of illustration only, and not for the purpose of limitation—the invention being defined by the claims.

What is claimed is:

1. A method for identifying attributable errors in a financial process, the method comprising:
(a) extracting financial data from a database;
(b) adding predetermined calculation fields to the data for evaluating performance of a financial process;
(c) determining whether values for a first calculation field are normally distributed; and
(d) in response to determining that the values are not normally distributed, dividing the data into first and second categories and performing a nested analysis of variance of the values for the first calculation field between the first and second categories to identify causes of the variance and correct the financial process.

2. The method of claim 1 wherein the financial data comprises healthcare-related financial data and adding predetermined calculation fields to the financial data includes adding a field for calculating the time between providing a healthcare service and submitting a bill for an account associated with the healthcare service.

3. The method of claim 2 wherein the first category is healthcare provider location and the second category is healthcare service provider and wherein performing the nested analysis of variance includes analyzing the variance for the time between providing a healthcare service and submitting a bill for the healthcare service among different service providers and different service provider locations.

4. The method of claim 1 wherein performing a nested analysis of variance between the categories includes generating a least squares means plot for the values for the first calculation field for the first and second categories.

5. The method of claim 1 wherein steps (b)-(d) are performed using statistical analysis software resident on a computer.

6. The method of claim 1 wherein the financial data in the database changes with time and steps (a)-(d) are performed periodically.

7. The method of claim 6 wherein performing steps (a)-(d) periodically includes performing the steps automatically using a computer program.

8. The method of claim 7 wherein the computer program is written in a scripting language.

9. The method of claim 8 wherein the scripting language is an open database connectivity (ODBC)-compliant language.

10. A method for identifying attributable errors in a financial process, the method comprising:
(a) extracting financial data from a database;
(b) adding a calculation field to the financial data for evaluating performance of a financial process. (c) plotting actual values for the calculation field versus modeled values for the calculation field;
(d) analyzing the plotted values and identifying predetermined data structures for which actual values differ from modeled values; and
(e) isolating one of the data structures and performing a factorial analysis on the data structure to determine causes for the variance between the actual and modeled values.

11. The method of claim 10 wherein extracting financial data from a database includes extracting healthcare-related financial data from a database.

12. The method of claim 10 wherein adding a calculation field includes adding a field containing actual payments on patient accounts.

13. The method of claim 12 wherein plotting actual versus modeled values for the selected field includes plotting actual versus modeled payments on the patient accounts.

14. The method of claim 10 wherein isolating one of the data structures includes isolating a data structure wherein a plurality of actual values correspond to a single modeled value.

15. The method of claim 10 wherein isolating one of the data structures includes isolating a data structure comprising a set of data points wherein actual values and modeled values differ by a constant amount.

16. The method of claim 10 wherein isolating a data structure includes isolating data points wherein actual and modeled values have a random or pseudorandom relationship with respect to each other.

17. The method of claim 10 wherein isolating one of the data structures includes identifying groups of data points forming predetermined shapes.

18. The method of claim 13 wherein isolating one of the data structures includes isolating a data structure for which a plurality of actual payments on patient accounts correspond to a single modeled payment.

19. The method of claim 13 wherein isolating one of the data structures includes isolating data points wherein actual and modeled account payments differ by a constant amount.

20. The method of claim 13 wherein isolating one of the structures includes isolating data points wherein actual and modeled account payments have a random or pseudo-random relationship with respect to each other.

21. The method of claim 18 wherein performing a factorial analysis on the isolated data structure includes:
(a) selecting first and second factors potentially responsible for variance between actual and expected account payments; and
(b) performing an effect test for each of the factors to eliminate one of the factors as a potential cause for the variance.

22. The method of claim 19 wherein performing a factorial analysis on the data structure includes:
(a) generating a histogram of the difference between actual and modeled account payments for the data points;
(b) identifying peaks in the histogram;
(c) determining the difference in revenue between the peaks in the histogram; and
(d) using the difference to correct modeled revenues.

23. The method of claim 20 wherein performing a factorial analysis on the structure includes identifying underperforming accounts using a control chart.

24. The method of claim 10 wherein steps (b)-(e) are performed using statistical analysis software resident on a computer.

25. The method of claim 10 wherein the financial data in the database changes with time and steps (a)-(e) are performed periodically.

26. The method of claim 25 wherein performing steps (a)-(e) periodically includes performing the steps automatically using a computer program.

27. The method of claim 26 wherein the computer program is written in a scripting language.

28. The method of claim 27 wherein the scripting language is an open database connectivity (ODBC)-compliant language.

29. A method for applying Kaplan-Meier survival analysis to a financial process, the method comprising:
(a) gathering data regarding a time-based financial process for a plurality of individual datasets;
(b) defining a birth for the financial process as the time of occurrence of a first financial event;
(c) defining the death of a financial process as the time of occurrence of a second financial event;
(d) plotting a Kaplan-Meier survival curve for each of the individual data sets using the definitions of birth and death defined in steps (b) and (c); and
(e) comparing the Kaplan-Meier survival curves for the individual data sets to determine the causes of variance between the individual data sets.

30. The method of claim 29 wherein the first financial event is provision of a healthcare service and the second financial event is receipt of payment for the service.

31. The method of claim 30 wherein the plurality of individual datasets represent payment times for different healthcare insurers.

32. The method of claim 29 wherein the first financial event is provision of a healthcare service and the second financial event is generation of an invoice for the service.

33. A computer program product comprising computer-executable instructions embodied in a computer-readable medium for performing steps comprising:
(a) extracting healthcare-related financial data from a database;
(b) adding predetermined calculation fields to the data for evaluating performance of a healthcare-related financial process;
(c) determining whether values for a first calculation field are normally distributed; and
(d) in response to determining that the values are not normally distributed, dividing the data into first and second categories and performing a nested analysis of variance of the values for the first calculation field between the first and second categories to identify causes of the variance and correct the financial process.

34. A computer program product comprising computer-executable instructions embodied in a computer-readable medium for performing steps comprising:
(a) extracting healthcare-related financial data from a database;
(b) adding a calculation field to the financial data for evaluating performance of a healthcare-related financial process.
(c) plotting actual values for the calculation field versus modeled values for the calculation field;
(d) analyzing the plotted values and identifying predetermined data structures for which actual values differ from modeled values; and
(e) isolating one of the data structures and performing a factorial analysis on the data structure to determine causes for the variance between the actual and modeled values.

35. A computer program product comprising computer-executable instructions embodied in a computer-readable medium for performing steps comprising:
(a) gathering data regarding a time-based financial process for a plurality of individual datasets;
(b) defining a birth for the financial process as the time of occurrence of a first financial event;
(c) defining the death of a financial process as the time of occurrence of a second financial event;
(d) plotting a Kaplan-Meier survival curve for each of the individual data sets using the definitions of birth and death defined in steps (b) and (c); and
(e) comparing the Kaplan-Meier survival curves for the individual data sets to determine the causes of variance between the individual data sets.
